(19) United States
(12) Patent Application Publication
(10) Pub. No.: US 2026/0046978 A1
(43) Pub. Date: Feb. 12, 2026

(54) SYSTEMS AND METHODS FOR HANDLING ONE OR MORE EMERGENCY SERVICES AT A USER EQUIPMENT

(71) Applicant: SAMSUNG ELECTRONICS CO., LTD., Suwon-si (KR)

(72) Inventors: Prasad Basavaraj DANDRA, Bengaluru (IN); Sivasankar COMARAVELOU, Bengaluru (IN); Chetan Ramesh GANIG, Bengaluru (IN); Danish Ehsan HASHMI, Bengaluru (IN); Lalith KUMAR, Bengaluru (IN); Mahmoud WATFA, Bengaluru (IN); Utsav SINHA, Bengaluru (IN)

(73) Assignee: SAMSUNG ELECTRONICS CO., LTD., Suwon-si (KR)

(21) Appl. No.: 19/294,974

(22) Filed: Aug. 8, 2025

(30) Foreign Application Priority Data
Aug. 11, 2024 (IN) 202441060644
Aug. 1, 2025 (IN) 202441060644

(51) Int. Cl. H04W 76/50; H04W 48/18; H04W 60/00; H04W 84/04

(52) U.S. Cl. CPC H04W 76/50; H04W 48/18; H04W 60/002; H04W 84/042

(57) ABSTRACT

A method for handling one or more emergency services at a User Equipment (UE) via a New Generation-Radio Access Technology (NG-RAN) satellite cell, includes: receiving, from one or more applications associated with the UE, a request to access the one or more emergency services; determining a Public Land Mobile Network (PLMN) from one or more lists of PLMNs, wherein the one or more lists of PLMNs comprises at least a list of PLMNs not allowed to operate in a current location of the UE; and accessing the one or more emergency services by establishing a connection with the NG-RAN satellite cell associated with the determined PLMN.

### CROSS-REFERENCE TO RELATED APPLICATIONS

This application is based on and claims priority under 35 U.S.C. § 119 to Indian Provisional Patent Application No. 202441060644, filed on Aug. 11, 2024, and Indian Non-Provisional Patent Application No. 202441060644, filed on Aug. 1, 2025, in the Indian Patent Office, the disclosures of which are incorporated by references herein in their entireties.

### BACKGROUND

The present disclosure relates generally to the field of communication networks, and more particularly, to a system and method for handling one or more emergency services at a User Equipment.

Background description includes information that may be useful in understanding the present disclosure. It is not an admission that any of the information provided herein is related art or relevant to the presently claimed disclosure, or that any publication specifically or implicitly referenced is related art.

Currently, there is increasing adoption of Non-Terrestrial Network (NTN) for ensuring connectivity in remote areas and areas where the Terrestrial Network (TN) are unavailable. There is a requirement to maintain continuity of service when a User Equipment (UE) moves between a TN coverage area and an NTN coverage area. This further leads to the requirement for adopting optimal procedures to ensure seamless connectivity between the UE and emergency services.

The selection and roaming of Public Land Mobile Network as provided in Technical Specification (TS) 23.122 are initiated by the UE when the following condition is fulfilled:
A mobile service (MS) that is attaching or attached for emergency bearer services or for access to ‘Radio Line of Sight’ (RLOS), or registering or registered for emergency services may access PLMNs in the list of “forbidden PLMNs” or the list of “forbidden PLMNs for GPRS service”. The MS may not remove any entry from the list of “forbidden PLMNs” or the list of “forbidden PLMNs for GPRS service” as a result of such accesses.

The service request procedure as provided in the TS 24.501 is initiated on fulfilling the service request procedure requirements. The service request procedure is initiated by the UE when the following conditions are fulfilled:
its 5GS update status is 5U1 UPDATED, and the Tracking Area Identity (TAI) of the current serving cell is included in a TAI list; and
no 5G Mobility Management (5GMM) specific procedure is ongoing.

Further, the UE does not invoke the service request procedure when the UE is in the state 5GMM-SERVICE-REQUEST-INITIATED.

The timers for 5GS mobility management (5GMM) at the UE side as provided in TS 24.501 are produced in Table 1. In Table 1, the NOTE 12 is “In satellite Next Generation Radio Access Network (NG-RAN) access, this value shall be selected when satellite NG-RAN RAT type is New Radio (NR) (Medium Earth Orbit (MEO)) or NR (Geostationary Earth Orbit (GEO))” and the corresponding timer value is selected.

TABLE 1

| TIMER | TIMER | | CAUSE OF | | ON |
|---|---|---|---|---|---|
| NUM. | VALUE | STATE | START | NORMAL STOP | EXPIRY |
| T3510 | 15 s NOTE 7 | 5GMM- | Transmission of | REGISTRATION | Start T3511 or |
| | NOTE 8 In | REGISTERED- | REGISTRATION | ACCEPT message | T3502 as specified |
| | WB-N1/CE | INITIATED | REQUEST | received or | in subclause |
| | mode, 85 s | | message | REGISTRATION | 5.5.1.2.7 if T3510 |
| | For access via | | | REJECT | expired during |
| | a satellite | | | message received | registration |
| | NG-RAN cell, | | | | procedure for |
| | 27 s (Based on | | | | initial registration. |
| | NOTE 12) | | | | Start T3511 or |
| | | | | | T3502 as specified |
| | | | | | in subclause |
| | | | | | 5.5.1.3.7 if T3510 |
| | | | | | expired during |
| | | | | | the registration |
| | | | | | procedure for |
| | | | | | mobility and |
| | | | | | periodic registration |
| | | | | | update |
| T3517 | (a) 5 s for case | 5GMM- | Transmission of | (a) Indication from | Abort the procedure |
| | h) in subclause | SERVICE- | SERVICE | the lower layers that | |
| | 5.6.1.1; or (b) | REQUEST- | REQUEST | the UE has changed | |
| | 15 s for cases | INITIATED | message, or | to S1 mode or | |
| | other than h) in | | CONTROL | E-UTRA connected | |
| | subclause | | PLANE | to 5GCN for case h) | |
| | 5.6.1.1 NOTE 7 | | SERVICE | in subclause 5.6.1.1; | |
| | NOTE 8 | | REQUEST | or (b) SERVICE | |
| | NOTE 10 In | | message | ACCEPT message | |
| | WB-N1/CE | | | received, or | |
| | mode, 61 s | | | SERVICE REJECT | |
| | For access via | | | message received | |
| | a satellite | | | for cases other than | |
| | NG-RAN cell, | | | h) in subclause | |
| | 27 s (Based on | | | 5.6.1.1 see subclause | |
| | NOTE 12) | | | 5.6.1.4.2 | |

Additionally, as per TS 23.501 clause 5.3.2.4, the UE performs registration over one access and intends to perform registration over the other access in the same PLMN (e.g. the 3GPP access and the selected Non-3GPP Interworking Function (N3IWF), Trusted Non-3GPP Gateway Function (TNGF) or Wireline Access Gateway Function (W-AGF) are located in the same PLMN). Then, in that case, the UE cannot initiate the registration over the other access until the registration procedure over the first access is completed. NOTE: which access the UE performs registration initially is up to the implementation of the UE.

Further, as per TS 24.501 Section 5.5.1.2.2 the UE cannot initiate an initial registration for emergency services over the current access if the UE is already registered for emergency services over the non-current access. The UE cannot initiate the initial registration unless the initial registration has to be initiated to perform the handover of an existing emergency Packet Data Unit (PDU) session from the non-current access to the current access. NOTE 1: Transfer of an existing emergency PDU session between 3GPP access and non-3GPP access is needed, for example, if the UE determines that the current access is no longer available. Further, the UE can only initiate the initial registration for emergency services over non-3GPP access if the UE cannot register for emergency services over 3GPP access.

Thus, currently, while establishing the emergency services when Non-Access Stratum (NAS) specific or connection management is in progress, the UE faces certain limitations. For instance, if a regular service has been initiated by the UE towards the network and the UE needs to establish a connection with emergency services, then in that scenario, the UE needs to wait until the regular services are completed. This leads to delays in the connection of the UE with the emergency services, thereby compromising the safety of the user. Further, when the UE wants to establish a connection with the emergency services and if there is any ongoing Mobility registration procedure other than the emergency services or not in the registration area or due to Inter-Radio Access Technology (IRAT) or due to capability update, the UE needs to wait until the mobility registration procedure is completed. Further, When UE wants to establish the connection with the emergency services in 3GPP access and there is ongoing registration on non-3GPP in same PLMN, then the UE needs to wait until the registration is completed on non-3GPP. Further, when only NTN cells/PLMN is available in the environment and if the PLMN is present in the list of “PLMN not allowed in current location” then the UE does not consider the PLMNs for emergency services resulting in no service.

In certain scenarios, the delay in the connection of the UE with the emergency services occurs due to availability of NTN PLMN within “PLMN not allowed in current location” List. Other conditions which impact the connection of the UE with the emergency services are as follows: emergency services handling while Mobility Management Specific or Connection Management procedure ongoing in Multi-Access environment (Wifi+Cellular) or Single-Access environment.

Therefore, there exists various problems in the existing techniques of handling procedures to ensure seamless connectivity between the UE and the emergency services, therefore, there lies a need for an improved system and method that can overcome the limitations and disadvantages of the existing techniques.

### SUMMARY

This summary is provided to introduce a selection of concepts, in a simplified format, that are further described in the detailed description of the disclosure. This summary is neither intended to identify essential inventive concepts of the disclosure nor is it intended for determining the scope of the disclosure.

According to an aspect of the disclosure, a method for handling one or more emergency services at a User Equipment (UE) via a New Generation-Radio Access Technology (NG-RAN) satellite cell, includes: receiving, from one or more applications associated with the UE, a request to access the one or more emergency services; determining a Public Land Mobile Network (PLMN) from one or more lists of PLMNs, wherein the one or more lists of PLMNs comprises at least a list of PLMNs not allowed to operate in a current location of the UE; and accessing the one or more emergency services by establishing a connection with the NG-RAN satellite cell associated with the determined PLMN.

According to an aspect of the disclosure, a method for maintaining N1 Non-Access Stratum (NAS) signalling connection at a User Equipment (UE) supporting one or more emergency services from a network, includes: transmitting a registration request for a second network slice associated with the network while the UE is registered with a first network slice with an established regular Packet Data Unit (PDU) providing one or more regular services and an established emergency PDU; in response to transmitting the registration request, initiating a predefined timer; and performing one of: maintaining the N1 Non-Access Stratum (NAS) signalling connection between the UE and the network in response to an expiry of the predefined timer and no response from the network for the transmitted registration request; or encoding an uplink data status to indicate an active state of the established emergency PDU in the registration request.

According to an aspect of the disclosure, a method for providing one or more emergency services or emergency service fallback at a User Equipment (UE), includes: transmitting, to a network via one of a 3GPP or a non-3GPP access, a first signalling request to access one or more regular services; receiving, from one or more applications associated with the UE, at least one of a request to access the one or more emergency services and an emergency service fallback request while the UE waiting for a response for the first signalling request; upon receiving the at least one of the request to access the one or more emergency services and the emergency service fallback request, performing at least one of: aborting a first signalling request procedure, or transmitting, to the network, at least one of a second signalling request to access the one or more emergency services and the emergency service fallback request; and transmitting, to the network, at least one of the second signalling request to access the one or more emergency services and the emergency service fallback request in parallel to the first signalling request.

According to an aspect of the disclosure, a system for handling one or more emergency services at a User Equipment (UE) via a New Generation-Radio Access Technology (NG-RAN) satellite cell, includes: a memory; at least one processor in communication with the memory, the at least one processor configured to: receive, from one or more applications associated with the UE, a request to access the one or more emergency services; determine a Public Land Mobile Network (PLMN) from one or more lists of PLMNs, wherein the one or more lists of PLMNs comprises at least a list of PLMNs not allowed to operate in a current location of the UE; and establish a connection with the NG-RAN satellite cell associated with the determined PLMN to access the one or more emergency services.

According to an aspect of the disclosure, a system for maintaining N1 Non-Access Stratum (NAS) signalling connection at a User Equipment (UE) supporting one or more emergency services from a network, includes: a memory; at least one processor in communication with the memory, the at least one processor configured to: transmit a registration request for a second network slice associated with the network while the UE is registered with a first network slice with an established regular Packet Data Unit (PDU) providing one or more regular services and an established emergency PDU; in response to transmitting the registration request, initiate a predefined timer; and perform one of: maintain the N1 Non-Access Stratum (NAS) signalling connection between the UE and the network in response to an expiry of the predefined timer and no response from the network for the transmitted registration request; or encode an uplink data status to indicate an active state of the established emergency PDU in the registration request.

According to an aspect of the disclosure, A system for providing one or more emergency services or emergency service fallback at a User Equipment (UE), includes: a memory; at least one processor in communication with the memory, the at least one processor configured to: transmit, to a network via one of a 3GPP or a non-3GPP access, a first signalling request to access one or more regular services; receive, from one or more applications associated with the UE, at least one of a request to access the one or more emergency services and the emergency service fallback request while the UE waiting for a response for the first signalling request; upon receiving the at least one of the request to access the one or more emergency services and an emergency service fallback request, perform at least one of: abort a first signalling request procedure, or transmit, to the network (206), at least one of a second signalling request to access the one or more emergency services and the emergency service fallback request; and transmitting, to the network, at least one of the second signalling request to access the one or more emergency services and the emergency service fallback request in parallel to first signaling request.

To further clarify the advantages and features of the present subject matter, a more particular description of the disclosure will be rendered by reference to specific embodiments thereof, which are illustrated in the appended drawings. It is appreciated that these drawings depict only typical embodiments of the disclosure and are therefore not to be considered limiting of its scope. The disclosure will be described and explained with additional specificity and detail with the accompanying drawings.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a flow diagram depicting problems faced by a User Equipment (UE) while establishing a connection with emergency services, in accordance with a conventional technique;

FIGS. 2A and 2B illustrates a sequence flow diagram associated with the availability of only NTN PLMNs from a list of PLMNs not allowed to operate at the present location of the UE, in accordance with a conventional technique;

FIGS. 3A and 3B illustrate a sequence flow diagram associated with a problem encountered by the UE while establishing a connection with the emergency services when the UE triggered registration for a network slice 2 (Second network slice), in accordance with a conventional technique;

FIGS. 4A, 4B, and 4C illustrate a sequence flow diagram associated with a problem encountered by the UE while establishing a connection with the emergency services, when the UE camps on each of a 3rd Generation Partnership Project (3GPP) access and a non-3GPP access, in accordance with a conventional technique;

FIGS. 5A and 5B illustrate a sequence flow diagram associated with a problem encountered by the UE while establishing a connection with the emergency services, when the UE include the PDU for the regular services in the case of the NG-RAN satellite-NTN, in accordance with a conventional technique;

FIGS. 6A, 6B, and 6C illustrate a sequence flow diagram associated with a problem encountered by the UE while establishing a connection with the emergency services, when the UE include the PDU for the regular services in the case of the NG-RAN-TN, in accordance with a conventional technique;

FIGS. 7A and 7B illustrate a sequence flow diagram associated with a problem encountered by the UE while establishing a connection with emergency fallback services, in accordance with a conventional technique;

FIGS. 8A and 8B illustrate a sequence flow diagram associated with a problem encountered by the UE while establishing a connection with the emergency services, when the UE include the PDU for the regular services and the emergency services, in accordance with a conventional technique;

FIGS. 9A and 9B illustrate a sequence flow diagram associated with a problem encountered by the UE 202 while establishing a connection with the emergency services, when the UE include the PDU for the regular services and the emergency services, in accordance with a conventional technique;

FIG. 10A illustrates an overview of a connection of the UE with the one or more emergency services, in accordance with an embodiment of the present disclosure;

FIG. 10B illustrates a block diagram of a system configured to handle the one or more emergency services at the UE, in accordance with an embodiment of the present disclosure;

FIGS. 11A and 11B illustrate a sequence flow diagram associated with establishing the connection with the NG-RAN satellite cell associated with the determined PLMN, in accordance with an embodiment of the present disclosure;

FIG. 12 illustrates a block diagram of a system configured for maintaining N1 Non-Access Stratum (NAS) signalling connection at the UE supporting the one or more emergency services from the network, in accordance with an embodiment of the present disclosure;

FIGS. 13A and 13B illustrate a sequence flow diagram associated with maintaining the N1 NAS signalling connection between the UE and the network by the system, in accordance with an embodiment of the present disclosure;

FIG. 14 illustrates a block diagram of a system configured for providing the one or more emergency services or emergency service fallback at the UE, in accordance with an embodiment of the present disclosure;

FIGS. 15A and 15B illustrate a sequence flow diagram for providing the one or more emergency services at the UE on the 3GPP access, in accordance with an embodiment of the present disclosure;

FIGS. 16A, 16B, 16C, and 16D illustrate a sequence flow diagram for establishing the connection of the one or more emergency services at the UE, when the UE includes the established regular PDU in the case of the NG-RAN-TN, in accordance with an embodiment of the present disclosure;

FIGS. 17A, 17B, and 17C illustrate a sequence flow diagram for establishing the connection of the one or more emergency services at the UE, when the UE includes the established regular PDU in case of eNB, in accordance with an embodiment of the present disclosure;

FIGS. 18A and 18B illustrate a sequence flow diagram for providing the emergency fallback service request, in accordance with an embodiment of the present disclosure;

FIGS. 19A and 19B illustrate a sequence flow diagram for establishing the one or more emergency services at the UE, when the UE receives a Data Radio Bearer (DRB) for each of the established regular PDU and the established emergency PDU, in accordance with an embodiment of the present disclosure;

FIGS. 20A and 20B illustrate a sequence flow diagram for establishing the connection of the one or more emergency services at the UE, when the UE is registered for the network slice 1 and is configured for the network slice 2, in accordance with an embodiment of the present disclosure;

FIGS. 21A and 21B illustrate a sequence flow diagram for establishing a connection of the one or more emergency services at the UE, when the UE is registered for the network slice 1 and is configured for the network slice 2, in accordance with another embodiment of the present disclosure;

FIG. 22 illustrates a process flow of the operation performed by the system as mentioned in FIG. 10B, in accordance with another embodiment of the present disclosure;

FIG. 23 illustrates a process flow of the operation performed by the system as mentioned in FIG. 12, in accordance with another embodiment of the present disclosure; and

FIG. 24 illustrates a process flow of the operation performed by the system as mentioned in FIG. 14, in accordance with another embodiment of the present disclosure.

Further, skilled artisans will appreciate those elements in the drawings are illustrated for simplicity and may not have necessarily been drawn to scale. For example, the flow charts illustrate the method in terms of the most prominent steps involved to help to improve understanding of aspects of the present subject matter. Furthermore, in terms of the construction of the device, one or more components of the device may have been represented in the drawings by conventional symbols, and the drawings may show only those specific details that are pertinent to understanding the embodiments of the present subject matter so as not to obscure the drawings with details that will be readily apparent to those of ordinary skill in the art having the benefit of the description herein.

### DETAILED DESCRIPTION

For the purpose of promoting an understanding of the principles of the disclosure, reference will now be made to the embodiment illustrated in the drawings and specific language will be used to describe the same. No limitation of the scope of the disclosure is thereby intended, such alterations and further modifications in the illustrated system, and such further applications of the principles of the disclosure as illustrated therein being contemplated as would normally occur to one skilled in the art to which the disclosure relates.

Those skilled in the art that the foregoing general description and the following detailed description are explanatory of the disclosure and are not intended to be restrictive thereof.

Reference throughout this specification to “an aspect”, “another aspect” or similar language means that a particular feature, structure, or characteristic described in connection with the embodiment is included in at least one embodiment of the present subject matter. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of operations does not include only those operations but may include other operations not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skilled in the art to which this disclosure belongs. The system, methods, and examples provided herein are illustrative only and not intended to be limiting.

The present disclosure relates to systems and methods for handling one or more emergency services. In an embodiment, the present disclosure relates to handling procedures and timers during Inter-Radio Access Technology (IRAT) movement between the TN and the NTN. The present disclosure further relates to handling procedures and timers associated with emergency service PDU sessions in the same RAT and during the IRAT movement between the NTN and the TN networks.

In an embodiment, a system and method are disclosed to establish an emergency service at a User Equipment. The system and method may establish the emergency services while:
a. a connection management procedure, for example, a service request procedure is pending for a service request procedure initiated for a reason other than emergency services or emergency services fallback or initiating a PDU connection for emergency bearer services. Further, the UE may abort the ongoing service request procedure, stop predefined timer, for example, T3517 if initiated and initiate a new service request procedure for emergency services, emergency services fallback or establishing a PDU connection for emergency bearer services;
b. While a service request procedure or a 5GSM procedure related to the emergency service is pending and mobility registration procedure initiated for a reason other than emergency services or emergency services fallback or initiating a PDU connection for emergency bearer services or not in registration area or due to IRAT or due to capability update. The UE may abort the ongoing Mobility registration procedure, stop predefined timer T3510 if initiated and initiate a new service request procedure for emergency services, emergency services fallback or establishing a PDU connection for emergency bearer services or initiate the pending 5GSM procedure related to emergency services;
c. While the UE is waiting for registration to be completed on non-3GPP access. Further, if the UE receives emergency service trigger in 3GPP access, UE may abort the ongoing registration on non-3GPP access and initiate registration for emergency services on 3GPP access;
d. In LTE, while a service request procedure is pending for service request procedure initiated for a reason other than CS fallback emergency call, 1×CS fallback emergency call or initiating a Packet Data Network (PDN) connection for emergency bearer services in LTE (applicable for all RATs in LTE). Further, the UE may abort the ongoing service request procedure, stop timer T3417, T3417ext or T3417ext-mt if initiated and initiate a new service request procedure for CS fallback emergency call, 1×CS fallback emergency call or establishing a PDN connection for emergency bearer services.

The system and method establish the emergency service, where:
a. the UE may not release the N1 NAS signalling connection due to Abnormal failures (like example T3510 expiry);
b. the UE may always encode the uplink data status as 1 for active Emergency PDU session when Registration or Service request is triggered.

The system and method establishes the emergency service where a mobile service that is attaching or attached for emergency bearer services or for access to ‘Radio Link Outage Start’ (RLOS), or registering or registered for emergency services, may access PLMNs in the list of “PLMNs not allowed to operate at the present UE location” as a result of such accesses.

Further, the pointers mentioned above are applicable for 5G, LTE, 6G & beyond.

The solutions as provided with the embodiments of the present disclosure are applicable to the known and possible variations of the UE mobility management timers and UE session management timers described in the existing techniques.

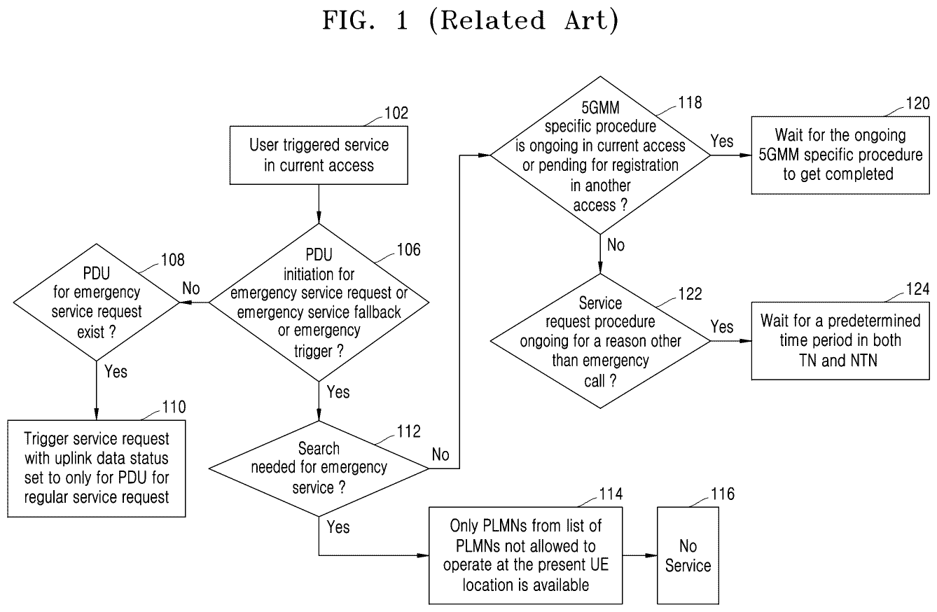

FIG. 1 illustrates a flow diagram depicting problems faced by a User Equipment (UE) while establishing a connection with emergency services, in accordance with a conventional technique.

Initially, at operation 102, a user triggers service in current access via the UE. Thereafter, at operation 106, the UE determines that if a trigger for initiation of a packet data unit (PDU) for emergency services or emergency service fallback or emergency is performed. When the UE determines that the trigger for the initiation is not performed, then in that case, at operation 108, the UE determines if the PDU for the emergency services or emergency service fallback or emergency exist. Further, when the UE determines that the PDU for the emergency services or emergency service fallback or emergency exist, in that case, at operation 110, the UE triggers one or more regular services (in short, “regular service”) with uplink data status set only for a PDU for the regular service.

Further, when the UE determines that the trigger for the initiation of the PDU for emergency or Service Request procedure for emergency services or emergency service fallback is performed, then in that case, at operation 112, the UE determines if a search is needed for the emergency services. When the UE determines that the search is needed for the emergency services in that case, at operations 114 and 116, the UE identifies that only Public Land Mobile Networks (PLMNs) from a list of PLMNs not allowed to operate at a present location of the UE is available, thereby, the UE reports no service to the user.

Additionally, when the UE determines that the search is not needed for the emergency services, in that case, at operation 118, the UE determines if 5G Mobility Management (MM) specific procedure is ongoing in the current access or pending for registration in another access. When the UE determines that the 5GMM specific procedure is ongoing in the current access or pending for registration in another access, in that case, at operation 120, the UE waits for the predefined timer for the ongoing 5GMM specific procedure to get completed to trigger pending emergency services. Further, when the UE determines that the 5GMM specific procedure is not ongoing in the current access or pending for registration in another access, then in that case, at operation 122, the UE determines if a service request is ongoing for a reason other than CS fall back emergency call, 1×CS fallback emergency call or initiating a PDN connection for emergency bearer services. Further, when the UE determines that the service request is ongoing for the reason other than CS fallback emergency call, 1×CS fallback emergency call or initiating a PDN connection for emergency bearer services, in that case, at operation 124, the UE waits for the predefined timer in each of a Non Terrestrial Network (NTN) and Terrestrial Network (TN).

Further each problem has been explained in the subsequent paragraph in detail.

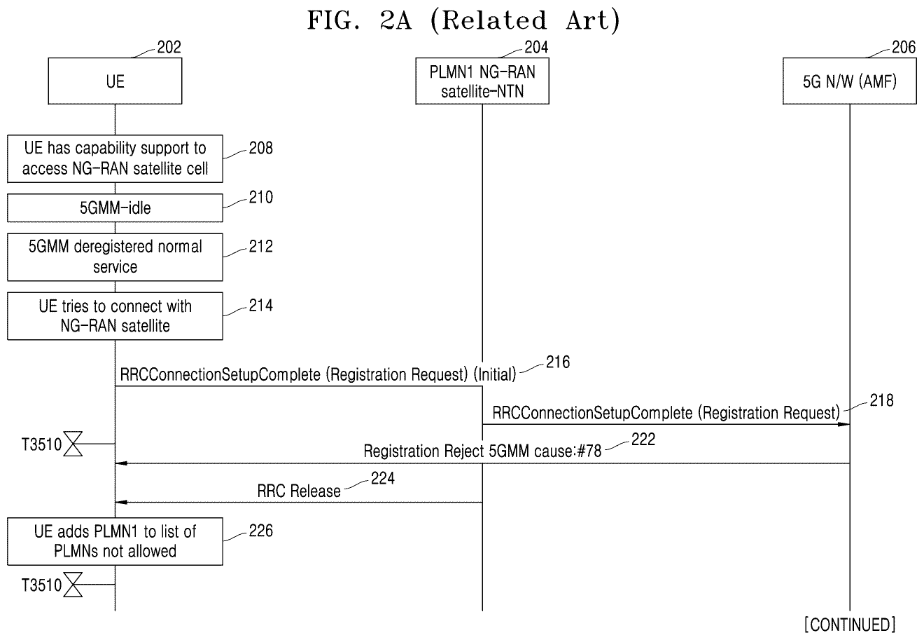

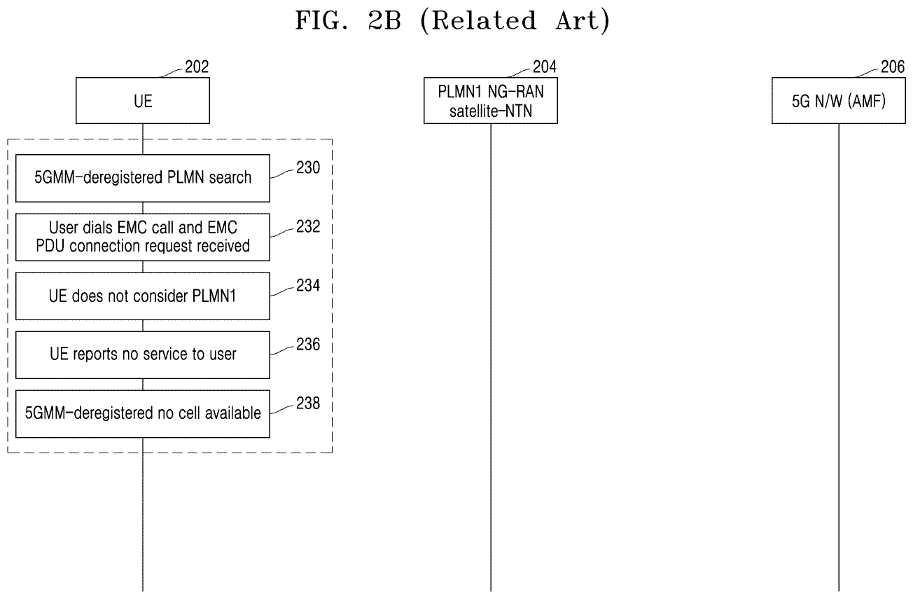

FIGS. 2A and 2B illustrate a sequence flow diagram associated with the availability of only NTN PLMNs (herein “PLMN1”) from the list of PLMNs not allowed to operate at the present location of the UE, in accordance with a conventional technique.

At operation 208, the UE 202 is in a location where only a New Generation-Radio Access Network (NG-RAN) satellite cell is available with a service provided from the PLMN1 204. Further, the UE 202 has the capability support to access the NG-RAN satellite cell.

At operation 210, the UE 202 camped on the network 206 and in an idle state. Thereafter, at operation 212, the UE 202 is in 5GMM deregistered normal state.

Further, at operation 214, the UE 202 tries to connect with the NG-RAN satellite cell for the normal/regular services. In this regard, at operation 216, the UE 202 sends a registration request in a RRCConnectionSetupComplete (Registration Request) (Initial) message to the PLMN1 204 initially. Thereafter, at operation 218, the PLMN1 204 transmits the registration request to the network in the RRCConnectionSetupComplete (Registration Request) message.

Further, the UE 202 initiates a predefined timer corresponding to T3510. At operation 222, the UE 202 receives the rejection of the registration from the network 206 in a registration reject 5GMM cause: #78—“PLMN not allowed to operate at the present UE location” message. Thereafter, at operation 224, the UE 202 receives Radio Resource Control (RRC) release from the PLMN1 NG-RAN Satellite-NTN 204.

Further, at operation 226, the UE 202 adds the PLMN1 204 to the list of the PLMNs not allowed to operate at the present location of the UE 202. Further, the UE 202 stops the predefined timer.

At operation 230, the UE 202 establishes the 5GMM deregistered PLMN search. Thereafter, at operation 232, the UE 202 receives a connection request for a establishing EMC PDU, i.e., the emergency PDU, for the emergency services, when the user dials the emergency call. Thereafter, the UE 202 tries to scan the cell which supports the emergency services.

At operation 234, the UE 202 does not consider PLMN1 204 and at operation 236, the UE 202 reports no service to the user. Thus, at operation 238, the UE 202 establishes no cell available in the 5GMM-deregistered no cell available message.

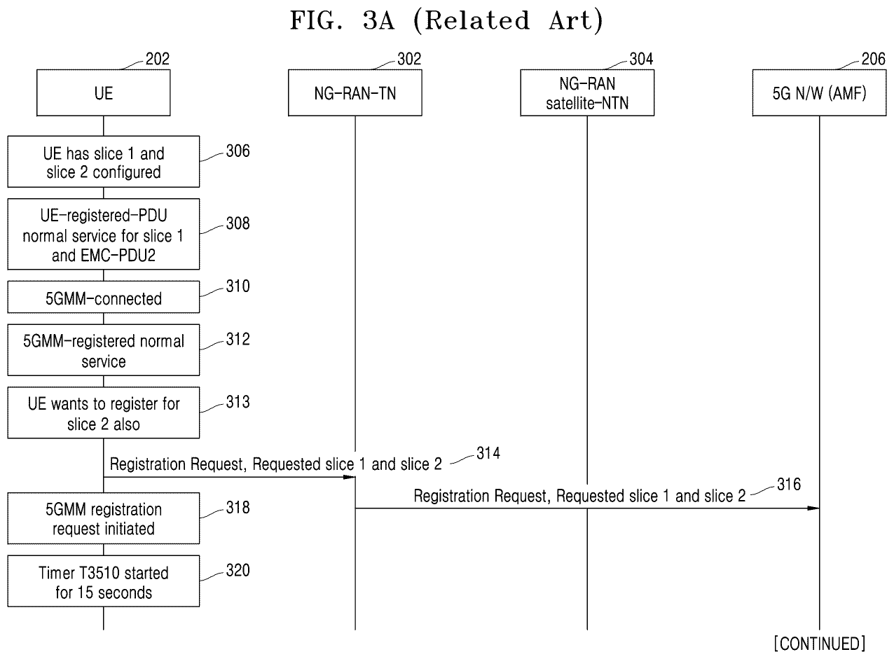

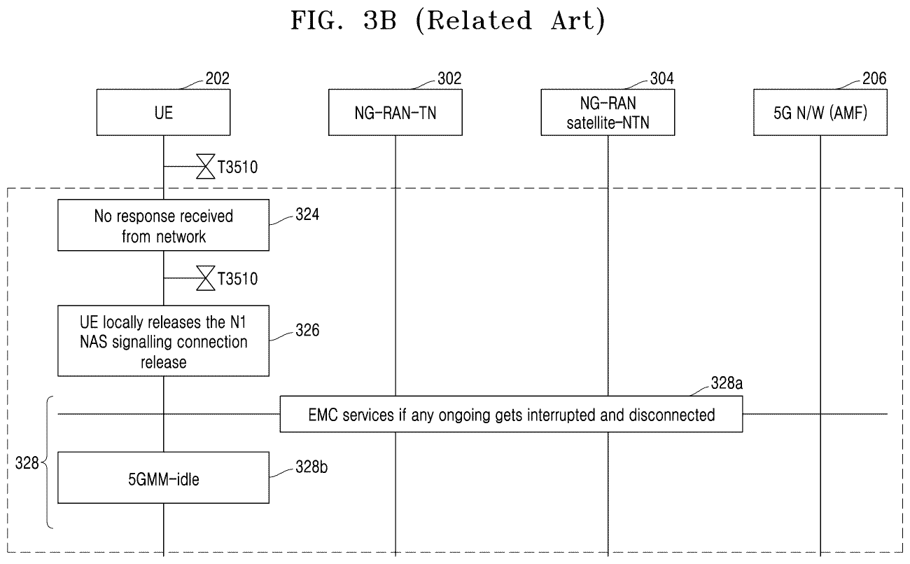

FIGS. 3A and 3B illustrate a sequence flow diagram associated with a problem encountered by the UE 202 while establishing a connection with the emergency services when the UE triggered registration for a network slice 2 (“second network slice”), in accordance with a conventional technique.

Herein, at operation 306, the UE 202 is registered for the network slice 1 and is configured for a network slice 2 (second network slice).

At operation 308, the UE 202 includes the PDU for the regular services and establishes a PDU for the emergency services.

At operation 310, the UE 202 is connected with the network 206 in a 5GMM-connected message. At operations 312 and 313, the UE is registered for the regular services in the 5GMM-registered normal service message and also wants to register for the network slice 2. Thereafter, at operation 313, the UE 202 wants to register for the network slice 2 also.

At operations 314 and 316, the UE 202 transmits the registration request (mobility registration) with the network slice 1 and the network slice 2 to the network 206 via NG-RAN-TN 302 or NG-RAN satellite-NTN 304. The UE 202 transmits the registration request in a Registration Request, Requested slice set with network slice 1 and network slice 2 message.

At operation 318, the UE 202 initiates a process of connecting to the network 206 in the 5GMM registration request message and, at operation 320, the UE 202 initiates the predefined timer of 15 seconds when the UE 202 access the NG-RAN-TN 302 or 27 seconds when the UE access the NG-RAN satellite-NTN 304. At operation 324, the UE 202 receives no response from the network 206 while the predefined timer is still continued.

At operation 326, the UE 202 locally releases the N1 NAS signalling connection on the expire of the predefined timer. Therefore, at operation 328 (328a, 328b), any ongoing emergency services on the UE 202 get interrupted and disconnected.

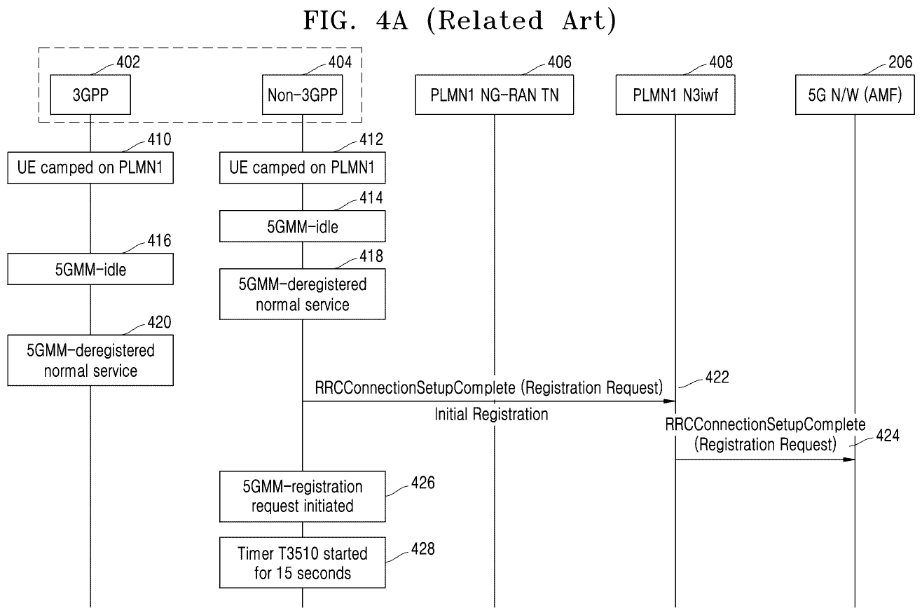

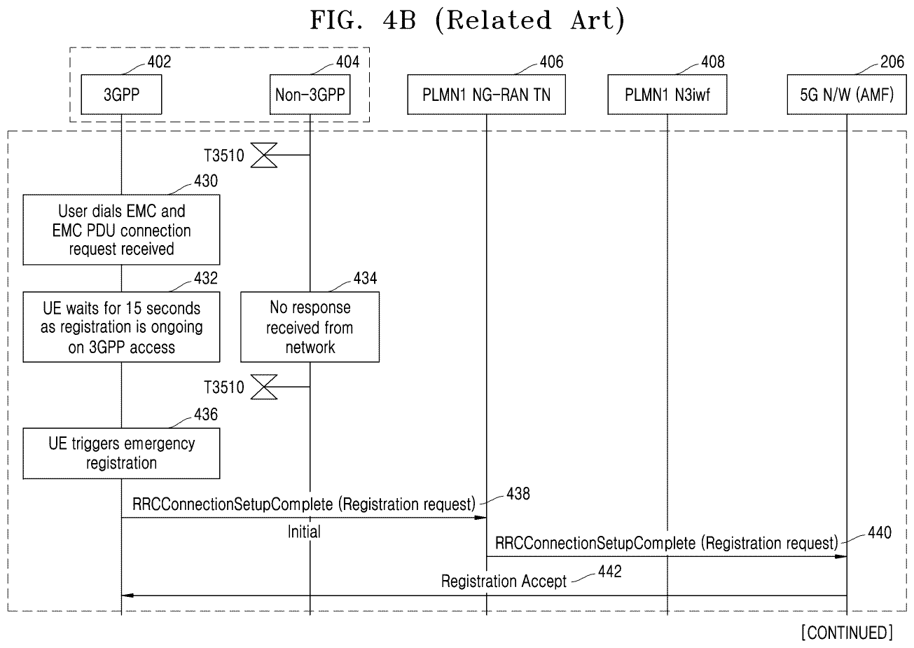

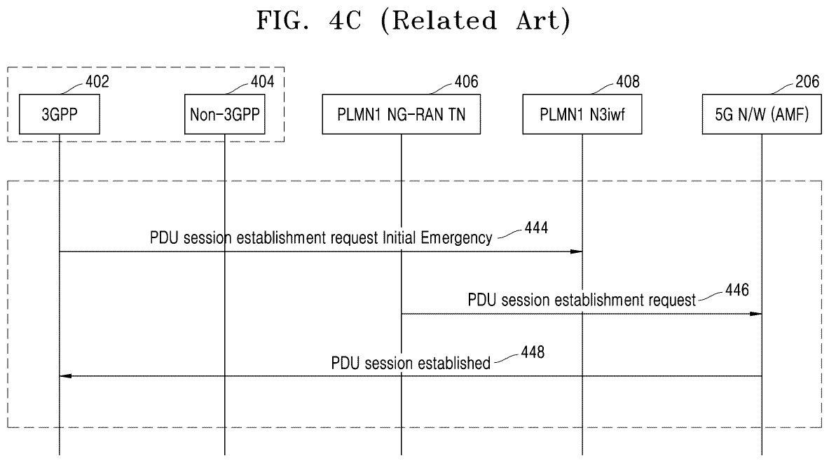

FIGS. 4A, 4B, and 4C illustrate a sequence flow diagram associated with a problem encountered by the UE 202 while establishing a connection with the emergency services, when the UE 202 camps on each of a 3rd Generation Partnership Project (3GPP) access 402 and a non-3GPP access 404, in accordance with a conventional technique.

At operations 410 and 412, the UE 202 camps on each of the 3rd Generation Partnership Project (3GPP) access 402 and the non-3GPP access 404 on same PLMN.

At operation 414, the UE 202 is connected to the network 206 but is in the idle state at the non-3GPP access 404.

At operation 416, the UE 202 is connected to the network 206 but is in the idle state on the 3GPP access 402.

At operation 418, the UE 202 deregistered normal service/regular services in a 5GMM-deregistered normal service message on the non-3GPP access 404.

At operation 420, the UE 202 deregistered normal service/regular services in a 5GMM-deregistered normal service message on the 3GPP access 402.

At operations 422 and 424, the UE 202 transmits a registration request of the non-3GPP access towards the network 206 via PLMN1 NG-RAN TN 406 and PLMN1 N3iwf 408 in the RRCConnectionSetupComplete (Registration Request) message.

At operation 426, the UE 202 initiates registration request on the non-3GPP access 404. Thereafter, at operation 428, the UE 202 initiates the predefined timer of 15 seconds on the non-3GPP access 404.

Further, at operation 430, the UE 202 receives the connection request of the established emergency PDU for the emergency services on the 3GPP access 402, when the user dials the emergency service.

At operation 432, the UE 202 waits for the predefined timer, i.e., 15 seconds as the registration is ongoing on the non-3GPP access 404.

Further, at operation 434, the UE 202 receives no response from the network 206 on the non-3GPP access 404. Herein, the predefined timer is still continued on the non-3GPP access 404. Thereafter, at operation 436, the UE 202 triggers the registration for the emergency services after completion of the ongoing registration of the non-3GPP access 404, thereby delaying the emergency services.

Further, at operations 438 and 440, the UE 202 transmits the registration request to the network 206 via the PLMN1 NG-RAN TN 406 in the RRCConnectionSetupComplete (Registration Request). In response, at operation 442, the UE 202 receives an acceptance of the registration from the network 206.

Thereafter, at operation 444, the UE 202 requests establishment of the PDU session in a PDU session establishment request Initial Emergency message. Further, at operation 446, the PLMN1 NG RAN TN 406 transmits the PDU session establishment request to the network 206 in a PDU session establishment request message.

Lastly, at operation 438, the UE 202 established the PDU session for the emergency services from the network 206.

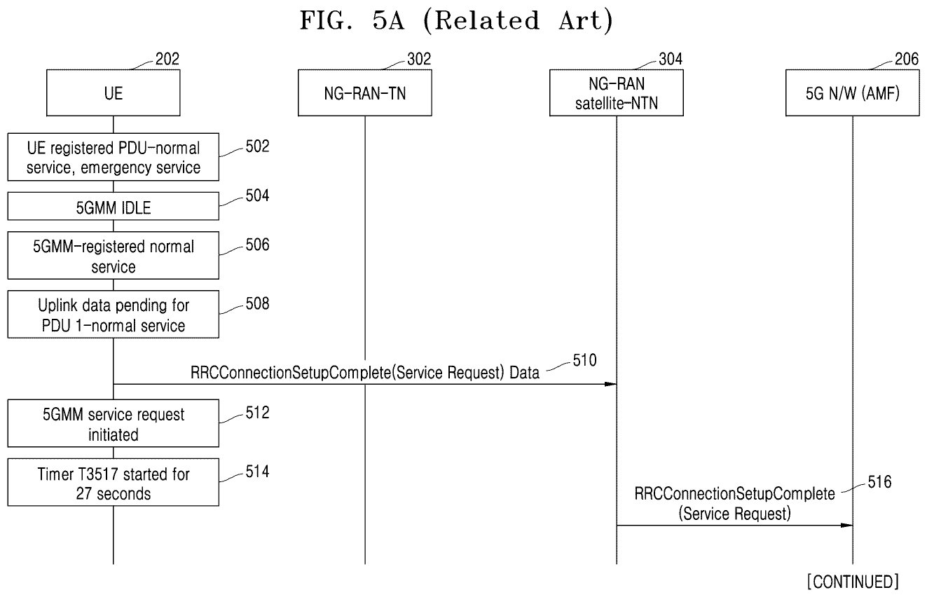

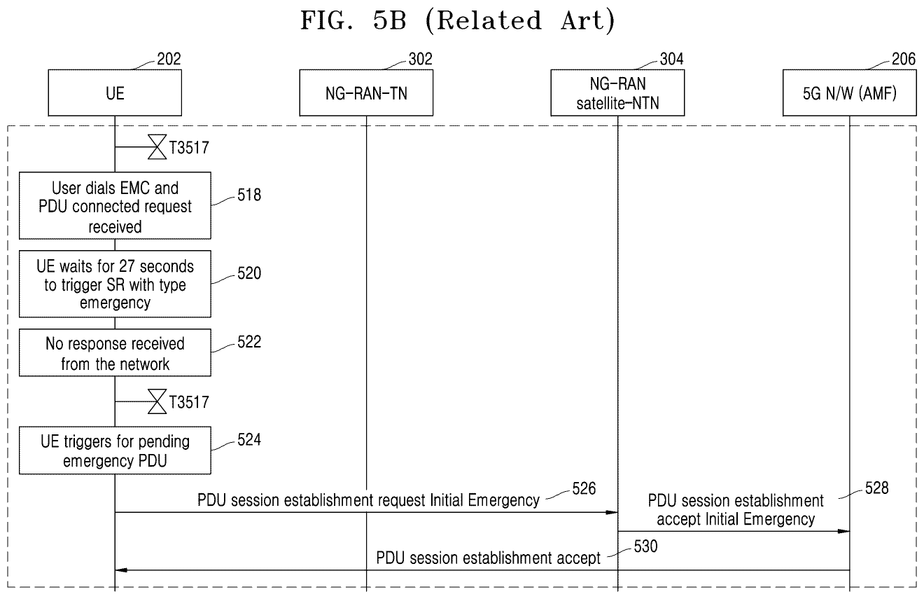

FIGS. 5A and 5B illustrate a sequence flow diagram associated with a problem encountered by the UE 202 while establishing a connection with the emergency services, when the UE 202 include the PDU for the regular services in the case of the NG-RAN satellite-NTN 304, in accordance with a conventional technique.

At operation 502, the UE 202 is registered with the network 206. Further, the UE 202 already established the PDU (PDU1) for the regular services.

At operation 504, the UE 202 is in the idle state indicated by the 5GMM idle message.

At operation 506, the UE 202 registered for the regular services and in the 5GMM-registered normal service state.

At operations 508 and 510, the one or more applications correspond to a regular PDU that triggers data transactions and, the UE 202 processes an uplink data pending for the PDU for the regular services and transmit to the NG-RAN satellite-NTN 304 in a RRCConnectionSetupComplete (Service Request) Data message.

At operation 512, the UE 202 initiates the service request in the 5GMM service request message.

At operation 514, the UE 202 initiates the predefined timer, i.e., 27 seconds from Timer T3517.

At operation 516, the NG-RAN satellite-NTN 304 transmits the service request to the network 206 in the RRCConnectionSetupComplete (service request) message.

Further, the predefined timer is continued and at operation 518, the UE 202 receives the emergency PDU connection request when the user dials an emergency call.

At operation 520, the UE 202 waits for the predefined timer to lapse to trigger the service request with a type ‘emergency’.

At operation 522, the UE 202 received no response from the network 206. Further, the predefined timer is still continued. Thereafter, at operation 524, the UE 202 triggers the PDU (pending emergency PDU) once the predefined timer is lapsed, thereby delaying the emergency services.

At operation 526, the UE 202 transmits the PDU session establishment request in the PDU session establishment request initial emergency message to the NG-RAN satellite-NTN 304. Further, at operation 528, the NG-RAN satellite-NTN 304 transmits the PDU session establishment request in PDU session establishment request initial emergency message.

At operation 530, the UE 202 accepts and establishes the PDU session for the emergency services as received from the network 206.

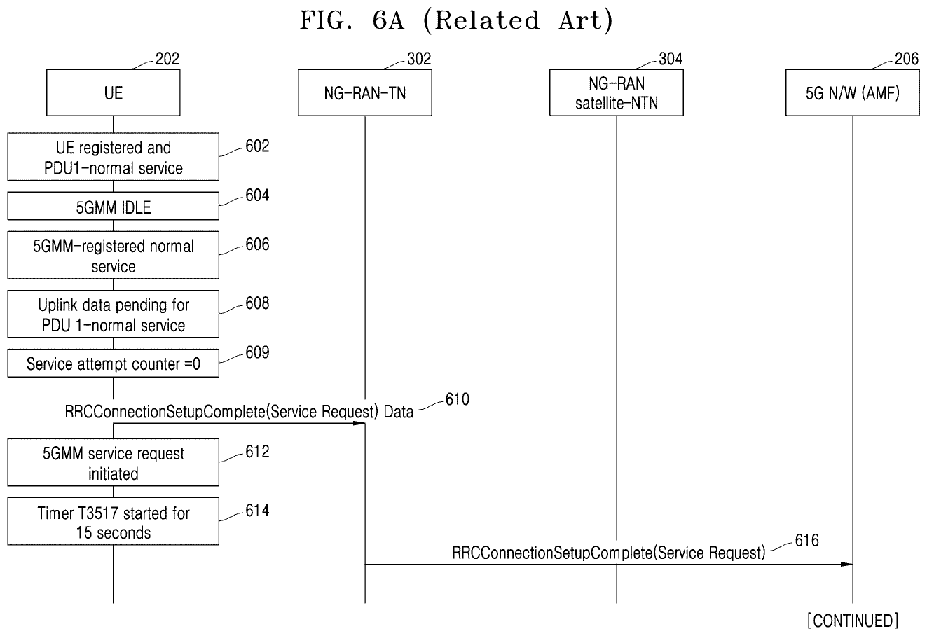

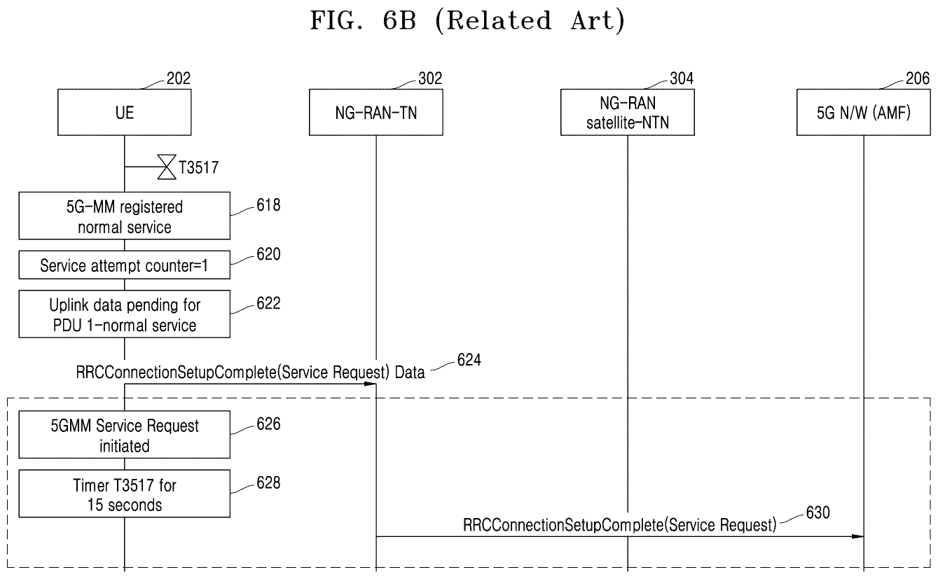

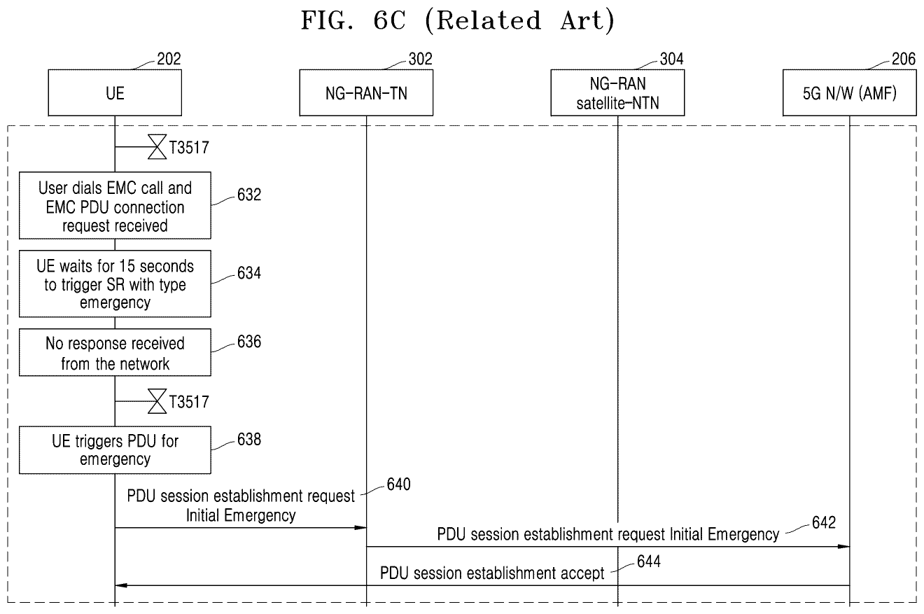

FIGS. 6A, 6B, and 6C illustrate a sequence flow diagram associated with a problem encountered by the UE 202 while establishing a connection with the emergency services, when the UE 202 include the PDU for the regular services in case of the NG-RAN-TN 302, in accordance with a conventional technique.

At operation 602, the UE 202 is registered with the network 206. Further, the UE 202 includes the PDU (PDU1) for the regular services.

At operation 604, the UE 202 is in the idle state indicated by the 5GMM idle message.

At operation 606, the UE 202 registers for the regular services and in the 5GMM-registered normal service state.

At operation 608, the one or more applications correspond to a regular PDU that triggers data transactions, the UE 202 processes the uplink data pending for the PDU for the regular services. At operation 609, the UE 202 monitors the service attempt counter as zero.

At operation 610, the UE 202 transmits the service request to the NG-RAN-TN 302 in the RRCConnectionSetupComplete (service request) data message.

At operation 612, the UE 202 initiates the service request in the 5GMM service request message.

At operation 614, the UE 202 initiates the predefined timer, i.e., 15 seconds from Timer T3517.

At operation 616, the NG-RAN-TN 302 transmits the service request to the network 206 in the RRCConnectionSetupComplete (service request) message.

Further, the predefined timer is expired and at operation 618, the UE 202 is in 5GMM registered normal service state. Thereafter, at operation 620, the UE 202 initiates the service attempt counter as 1.

At operation 622, the UE 202 processes the uplink data pending for the PDU for the regular services.

At operation 624, the UE 202 transmits the service request to the NG-RAN-TN 302 in the RRCConnectionSetupComplete (service request) data message.

At operation 626, the UE 202 initiates the service request in the 5GMM service request message.

At operation 628, the UE 202 initiates the predefined timer, i.e., 15 seconds from Timer T3517.

At operation 630, the NG-RAN-TN 302 transmits the service request to the network 206 in the RRCConnectionSetupComplete (service request) message.

Further, the predefined timer is continued, and at operation 632, the UE 202 receives the emergency PDU connection request when the user dials emergency call.

At operation 634, the UE 202 waits for the predefined timer to lapse to trigger the service request with a type ‘emergency’.

At operation 636, the UE 202 received no response from the network 206. Further, the predefined timer is still continued. Thereafter, at operation 638, the UE 202 triggers the PDU for the emergency services once the predefined timer is lapsed, thereby delaying the emergency services.

At operation 640, the UE 202 transmits the request for the PDU session establishment in the PDU session establishment request initial emergency message to the NG-RAN-TN 302. Further, at operation 642, the NG-RAN-TN 302 transmits the request for the PDU session establishment in the PDU session establishment request initial emergency message.

At operation 644, the UE 202 accepts and establishes the PDU session for the emergency service as received from the network 206.

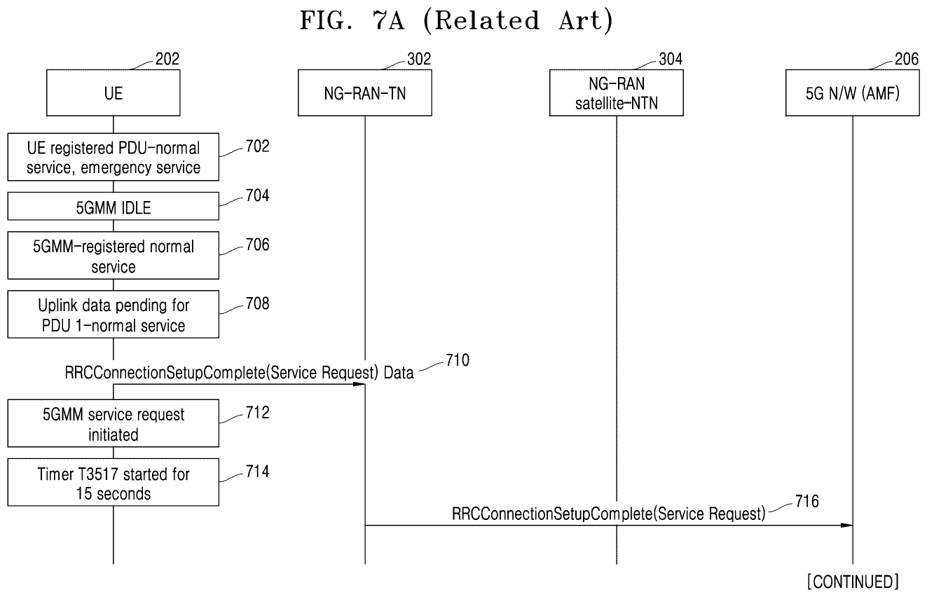

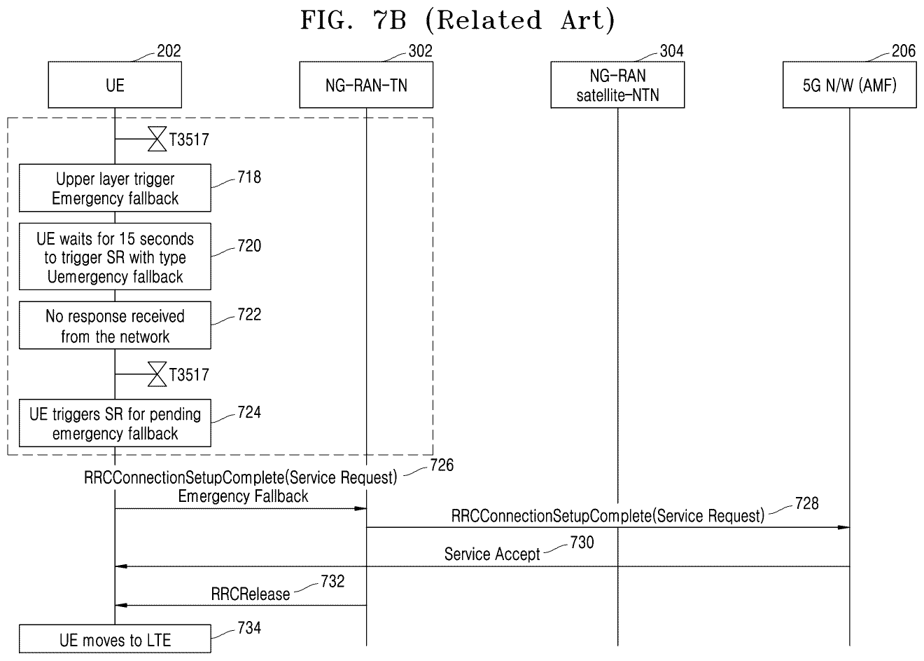

FIGS. 7A and 7B illustrate a sequence flow diagram associated with a problem encountered by the UE 202 while establishing a connection with emergency fallback services, in accordance with a conventional technique.

At operation 702, the UE 202 is registered in the network 206. Further, the UE 202 includes the PDU (PDU1) for the regular services and the PDU for the emergency services.

At operation 704, the UE 202 is in the idle state indicated by the 5GMM idle message.

At operation 706, the UE 202 registers for the regular services in the 5GMM-registered normal service message.

At operation 708, the one or more applications correspond to a regular PDU that triggers data transactions, and the UE 202 processes the uplink data pending for the PDU for the regular services.

At operation 710, the UE 202 transmits the service request to the NG-RAN-TN 302 in the RRCConnectionSetupComplete (service request) data message.

At operation 712, the UE 202 initiates the service request in the 5GMM service request message.

At operation 714, the UE 202 initiates the predefined timer, i.e., 15 seconds from the Timer T3517.

At operation 716, the NG-RAN-TN 302 transmits the service request to the network 206 in the RRCConnectionSetupComplete message.

Further, the predefined timer is continued and at operation 718, the UE 202, specifically an upper layer of the UE 202 triggers emergency fallback.

At operation 720, the UE 202 waits for the predefined timer to lapse to trigger the service request with a type ‘emergency’ fallback.

At operation 722, the UE 202 received no response from the network 206. Further, the predefined timer is still continued. Thereafter, at operation 724, the UE 202 triggers the service request once the predefined timer is lapsed, thereby delaying the emergency services.

At operation 726, the UE 202 transmits the service request to the NG-RAN-TN 302 in the RRCConnectionSetupComplete (Type as Emergency Fallback) message. Thereafter, at operation 728, the NG-RAN-TN 302 transmits the service request to the network 206 in the RRCConnectionSetupComplete (service request) message.

At operation 730, the UE 202 receives the acceptance of the service from the network 206

At operation 732, the UE 202 receives the RRC release redirect-E-UTRAN from the NG-RAN-TN 302. Further, at operation 734, the UE 202 moves to the LTE and establishes the PDU for the emergency services.

Further, the same scenario is possible in NTN, and UE needs to wait for 27 seconds at to trigger SR for Emergency service fallback.

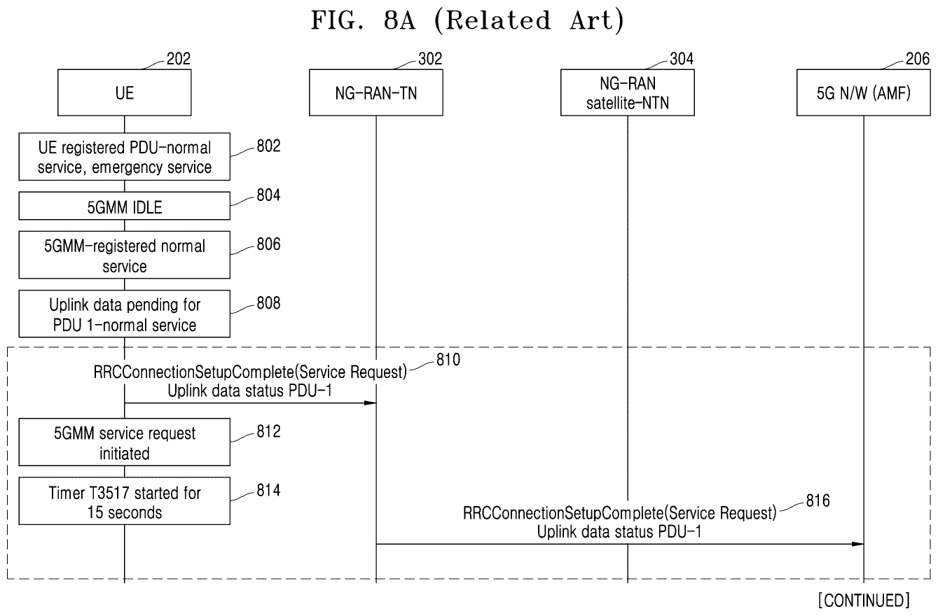

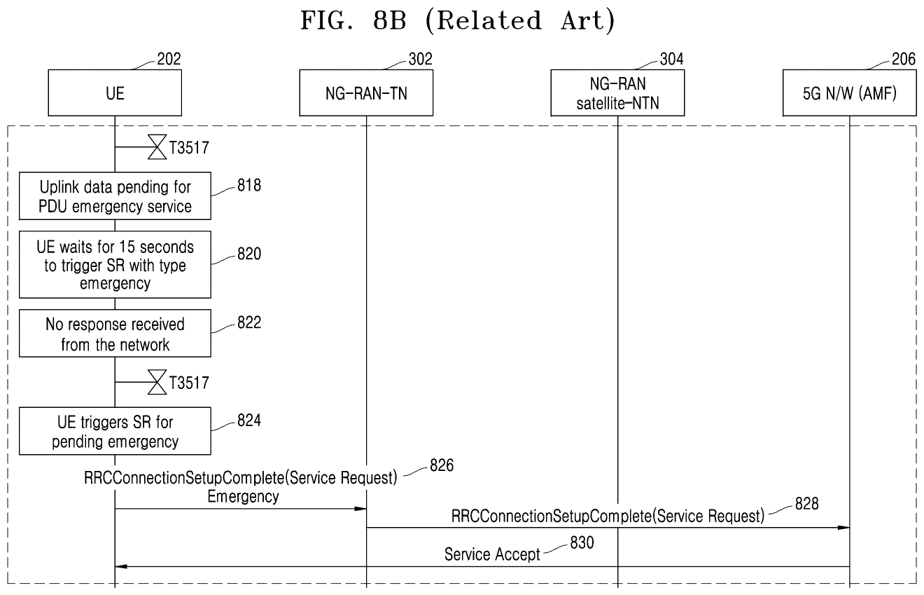

FIGS. 8A and 8B illustrate a sequence flow diagram associated with a problem encountered by the UE 202 while establishing a connection with the emergency services, when the UE 202 include the PDU for the regular services and the emergency services, in accordance with a conventional technique.

At operation 802, the UE 202 is registered with the network 206. Further, the UE 202 includes the PDU (PDU1) for the regular services and the PDU2 for the emergency services.

At operation 804, the UE 202 is in the idle state indicated by the 5GMM idle message.

At operation 806, the UE 202 register for the regular services in the 5GMM-registered normal service message.

At operation 808, the one or more applications correspond to a regular PDU that triggers data transactions, and the UE 202 processes the uplink data pending for the PDU for the regular services.

At operation 810, the UE 202 transmits a service request to the NG-RAN-TN 302 in the RRCConnectionSetupComplete (service request) uplink data status PDU1 message.

At operation 812, the UE 202 initiates the service request in the 5GMM service request message.

At operation 814, the UE 202 initiates the predefined timer, i.e., 15 seconds from the Timer T3517.

At operation 816, the NG-RAN-TN 302 transmits the service request to the network 206 in the RRCConnectionSetupComplete (service request) uplink data status PDU1 message.

Further, the predefined timer is continued and at operation 818, the one or more applications correspond to emergency PDU triggers data transactions, and the UE 202 waits for the uplink data pending for the PDU2.

At operation 820, the UE 202 waits for the predefined timer to lapse to trigger the service request with the type ‘emergency’.

At operation 822, the UE 202 received no response from the network 206. Further, the predefined timer is still continued. Thereafter, at operation 824, the UE 202 triggers the service request for the pending emergency once the predefined timer is lapsed, thereby delaying the emergency services.

At operation 826, the UE 202 transmits the service request to the NG-RAN-TN 302 in the RRCConnectionSetupComplete (service request) message. Thereafter, at operation 828, the NG-RAN-TN 302 transmits the service request to the network 206 in the RRCConnectionSetupComplete (service request) message.

At operation 830, the UE 202 receives the acceptance of the service from the network 206

Further, the same scenario is possible in NTN, and UE needs to wait for 27 seconds to trigger the service request (SR) for the emergency PDU.

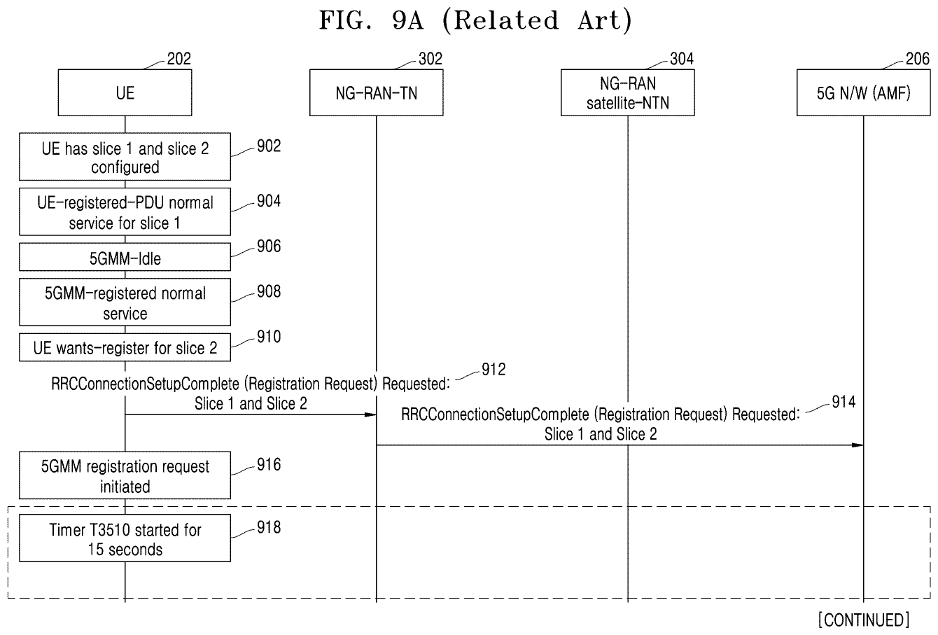

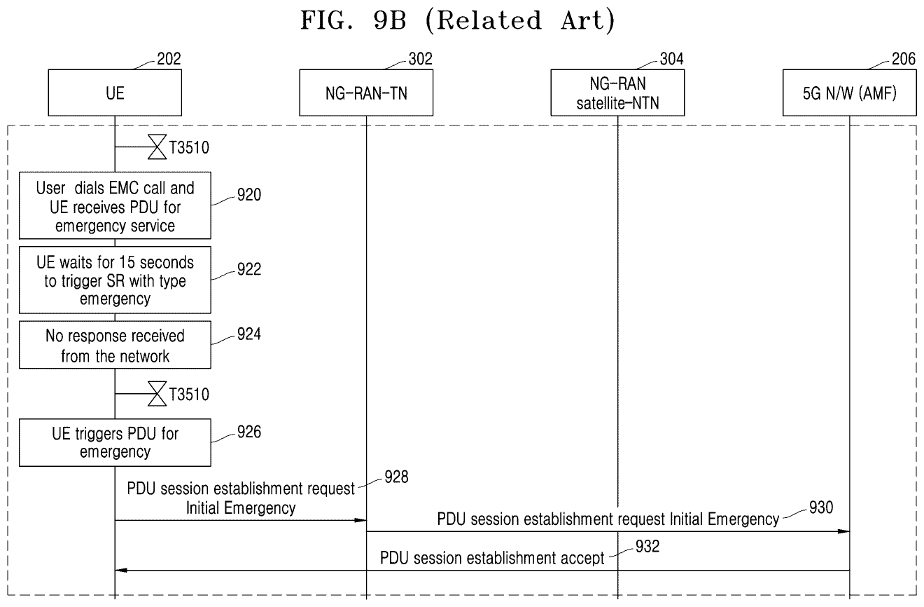

FIGS. 9A and 9B illustrate a sequence flow diagram associated with a problem encountered by the UE 202 while establishing a connection with the emergency services, when the UE 202 include the PDU for the regular services and the emergency services, in accordance with a conventional technique.

Herein, at operation 906, the UE 202 is registered for the network slice 1 (first network slice) and is configured for the network slice 2 (second network slice).

At operation 904, the UE 202 has the PDU for the regular services, specifically, for the network slice 1.

At operation 906, the UE 202 is connected with the network 206 and is in the idle state. At operations 908 and 910, the UE 202 is registered for the regular services in the 5GMM-registered normal service message and also wants to register for the network slice 2.

At operations 912 and 914, the UE 202 transmits the registration request (mobility registration) with the network slice 1 and the network slice 2 to the network 206 via the NG-RAN-TN 302 or the NG-RAN satellite-NTN 304. The UE 202 transmits the registration request in a RRCConnectionSetupComplete (Registration Request) Requested: Slice with Slice 1 and Slice 2 message.

At operation 916, the UE 202 initiates the registration request in 5GMM registration request and at operation 918, the UE 202 initiates the predefined timer of 15 seconds.

At operation 920, the UE 202 receives the PDU for the emergency services when the user dials emergency calls.

At operation 922, the UE 202 waits for the predefined timer to lapse and the ongoing mobility registration to get over to trigger a service request with type emergency, thereby delaying the emergency services.

At operation 924, the UE 202 received no response from the network 206.

At operation 926, upon expiration of the predefined timer, the UE 202 triggers the PDU for the emergency services. At operations 928, 930, the UE 202 transmits the request for the PDU establishment session to the network 206 in the PDU session establishment request Initial Emergency message. Further, at operation 932, the PDU session is established between the UE 202 and the network 206 in a PDU session establishment accept message 932.

Further, the same scenario is possible in NTN, and UE needs to wait for 27 seconds to trigger the PDU for the emergency services.

Thus, to overcome the abovementioned problems, the present disclosure discloses the following example embodiments of systems and methods.

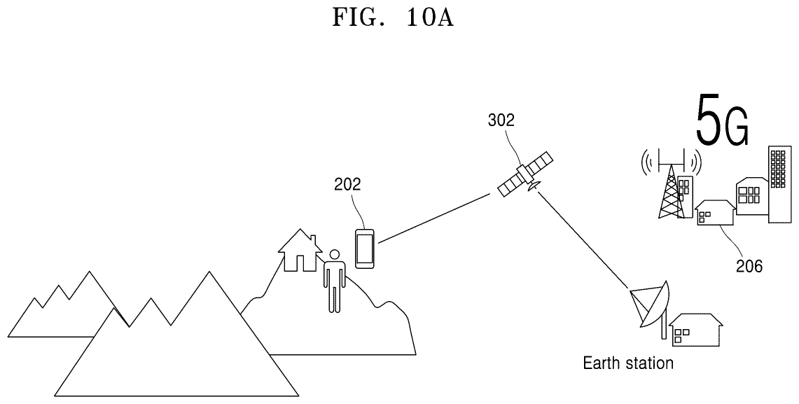

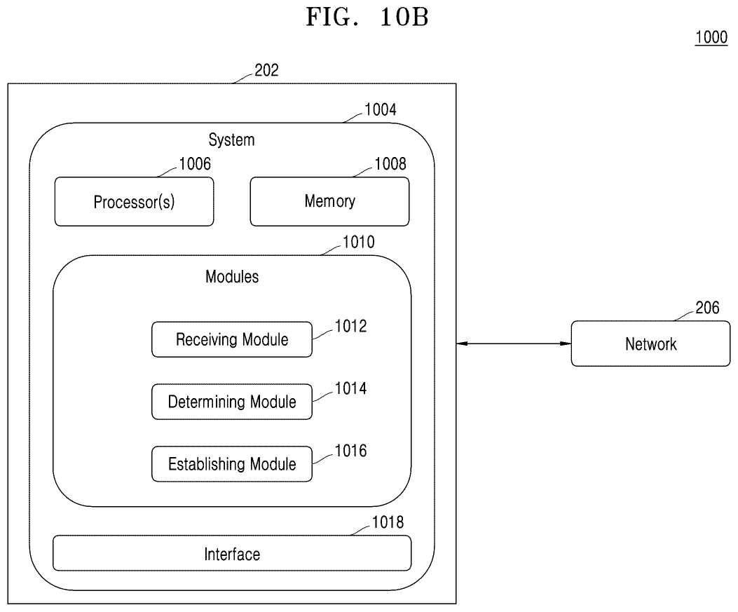

FIG. 10A illustrates an overview of a connection of the UE 202 with the one or more emergency services, without departing from the scope of the present disclosure. FIG. 10B illustrates a block diagram 1000 of a system 1004 configured to handle the one or more emergency services at the UE 202.

In an embodiment, when a user is abandoned in some remote area such that there is no one or more normal/regular services connected with the UE 202 of the user, in that case, the user requires the connection with the one or more emergency services. So, to establish the one or more emergency services or to handle the one or more emergency services in the UE, the system 1004 is disclosed. The system 1004 may be deployed in the UE 202, without departing from the scope of the present disclosure. In another embodiment, the system 1004 may be in communication with the UE 202, without departing from the scope of the present disclosure.

The system 1004 may include at least one processor 1006 (in short, “the processor 602”), a memory 1008, one or more modules 1010 (in short, “the modules 1010”), and an interface 1018. In an embodiment, the processor 1006 may be in communication with the memory 1008, the modules 1010, and the interface 1018.

In one embodiment, the processor 1006 may include at least one data processor for executing processes in Virtual Storage Area Network. The processor 1006 may include specialized processing units such as integrated system (bus) controllers, memory management control units, floating point units, graphics processing units, digital signal processing units, etc. In one embodiment, the processor 1006 may include a Central Processing Unit (CPU), a Graphics Processing Unit (GPU), or both. The processor 1006 may be one or more general processors, Digital Signal Processors (DSPs), application-specific integrated circuits, Field-Programmable Gate Arrays (FPGAs), servers, networks, digital circuits, analog circuits, combinations thereof, or other now known or later developed devices for analyzing and processing data. The processor 1006 may execute a software program, such as code generated manually (i.e., programmed) to perform the desired operation. The processor 1006 may implement various techniques such as, but not limited to, image processing, data extraction, Artificial Intelligence (AI), Machine Learning (ML), Deep Learning (DL), and so forth to achieve the desired objective.

In one embodiment, the processor 1006 may be configured to perform the functions of the system 1004.

The processor 1006 may be disposed in communication with one or more Input/Output (I/O) devices, such as the system 1004, via the interface 1018. The interface 1018 may employ communication Code-Division Multiple Access (CDMA), High-Speed Packet Access (HSPA+), Global System for Mobile Communications (GSM), Long-Term Evolution (LTE), WiMax, or the like, etc.

In an embodiment, the processor 1006 may be disposed in communication with a communication network via a network interface. In an embodiment, the network interface may be the interface 1018. The network interface may connect to the communication network to enable connection of the system 1004 with the outside environment and/or device/system. The network interface may employ connection protocols including, without limitation, direct connect, Ethernet (e.g., twisted pair 10/100/1000 Base T), Transmission Control Protocol/Internet Protocol (TCP/IP), token ring, IEEE 802.11/b/g/n/x, etc. The communication network may include, without limitation, a direct interconnection, Local Area Network (LAN), Wide Area Network (WAN), wireless network (e.g., using Wireless Application Protocol (WAP)), the Internet, etc. Using the network interface and the communication network, the system 1004 may communicate with other devices. The network interface may employ connection protocols including, but not limited to, direct connect, Ethernet (e.g., twisted pair 10/100/1000 Base T), TCP/IP, token ring, IEEE 802.11/b/g/n/x, etc.

The memory 1008 may be in communication with the processor 1006. The memory 1008 may be configured to store data and instructions executable by the processor 1006. In one embodiment, the memory 1008 may communicate via a bus within the system 1004. The memory 1008 may include, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 1008 may include a cache or random-access memory for the processor 1006. In alternative examples, the memory 1008 is separate from the processor 1006, such as a cache memory of a processor, the system memory, or other memory. The memory 1008 may be an external storage device or database for storing data. The memory 1008 may be operable to store instructions executable by the processor 1006. The functions, acts, or tasks illustrated in the figures or described may be performed by the programmed processor 1006 for executing the instructions stored in the memory 1008. The functions, acts, or tasks are independent of the particular type of instruction set, storage media, processor, or processing strategy and may be performed by software, hardware, integrated circuits, firmware, micro-code, and the like, operating alone or in combination. Likewise, processing strategies may include multiprocessing, multitasking, parallel processing, and the like. The memory 1008 may further include a database to store the data. Further, the memory 1008 may include an operating system for performing one or more tasks of the system 1004, as performed by a generic operating system in the communications domain.

In one embodiment, the memory 1008 may be configured to store the information as required by the processor 1006 to perform the techniques described herein.

The modules 1010, amongst other things, include routines, programs, objects, components, data structures, etc., which perform particular tasks or implement data types. The modules 1010 may also be implemented as, signal processor(s), state machine(s), logic circuitries, and/or any other device or component that manipulates signals based on operational instructions. The modules 1010 may be configured to one or more operations of the system 1004 and/or the processor 1006.

Further, the modules 1010 can be implemented in hardware, instructions executed by a processing unit, or by a combination thereof. The processing unit can comprise a computer, the processor 1006, a state machine, a logic array, or any other suitable devices capable of processing instructions. The processing unit can be a general-purpose processor which executes instructions to cause the general-purpose processor to perform the required tasks, or the processing unit can be dedicated to performing the required functions. In another embodiment of the present disclosure, the modules 1010 may be machine-readable instructions (software) that, when executed by a processor/processing unit, perform any of the described functionalities. Furthermore, the data serves, amongst other things, as a repository for storing data processed, received, and generated by one or more of the modules. The modules 1010 may include a receiving module 1012, a determining module 1014, and an establishing module 1016.

The receiving module 1012 may be configured to receive a request to access the one or more emergency services. The receiving module 1012 may be configured to receive the request from one or more applications associated with the UE 202. In such an embodiment, the one or more applications correspond to different types of emergency applications, for example, eCall application, cell broadcast service, 112 (e.g., emergency service number in some countries like South Korea) and or 911 (e.g., emergency service number in some countries like the United States) application, etc.

In an embodiment, the determining module 1014 may be configured to determine a Public Land Mobile Network (PLMN) from one or more lists of PLMNs. The one or more lists of PLMNs may include, but is not limited to, at least a list of PLMNs not allowed to operate in a current location of the UE. Additionally, the one or more lists may include one or more lists of forbidden PLMNs other than the list of PLMN not allowed to operate in the current location of the UE 202.

In an embodiment, the establishing module 1016 may be configured to establish a connection with a New Generation-Radio Access Technology (NG-RAN) satellite cell associated with the determined PLMN to access the one or more emergency services from the network 206.

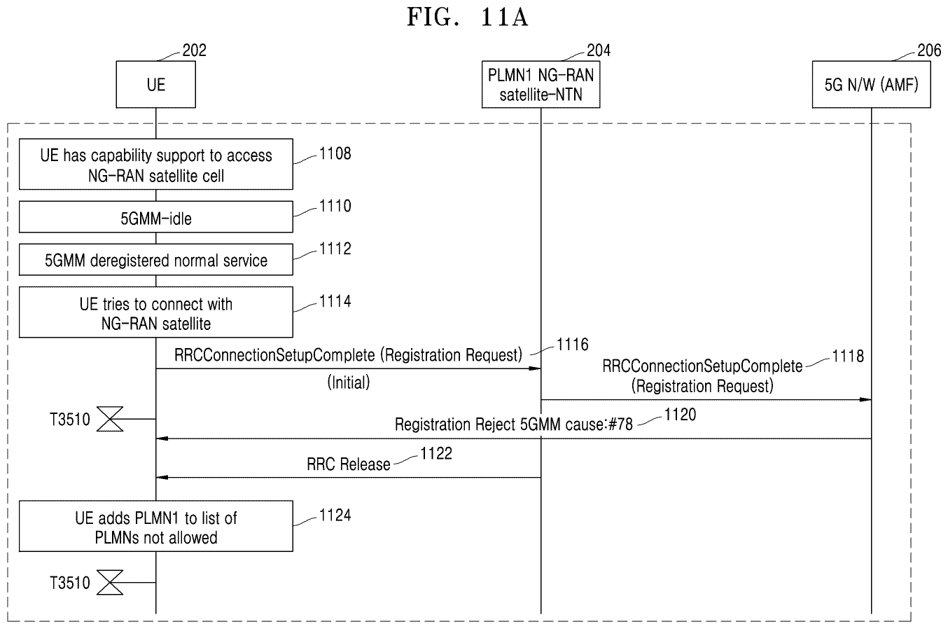

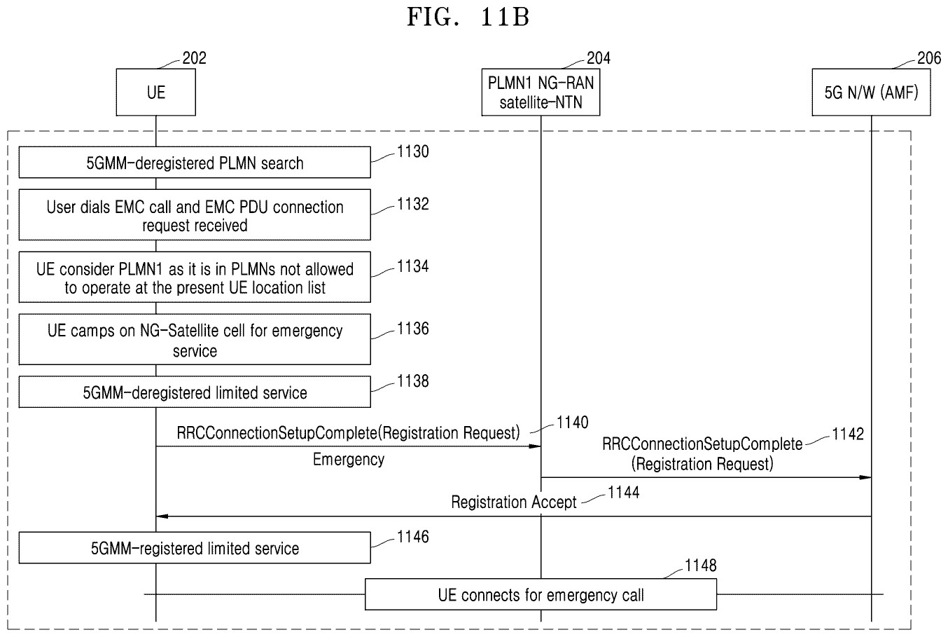

FIGS. 11A and 11B illustrate a sequence flow diagram associated with establishing the connection with the NG-RAN satellite cell associated with the determined PLMN, in accordance with an embodiment of the present disclosure.

At operation 1108, the UE 202 is in the location where only the NG-RAN satellite cell may be available with the service provided from the PLMN1 204. Further, the UE 202 has the capability support to access the NG-RAN satellite cell.

At operation 1110, the UE 202 establishes a connection with the network 206 but is in an idle state. Thereafter, at operation 1112, the UE 202 is in 5GMM deregistsred normal state. Particularly, the UE 202 may not be currently registered with the network 206 but remains camped on the network 106 and may be allowed to initiate registration or access emergency services.

Further, at operation 1114, the UE 202 tries to connect with the NG-RAN satellite cell for the one or more normal/regular services. In this regard, at operation 1116, the UE 202 transmits the connection request to the PLMN1 204 in a RRCConnectionSetupComplete (Registration Request) (Initial) message. Thereafter, at operation 1118, the PLMN1 204 transmits the registration request to the network 206 in the RRCConnectionSetupComplete (Registration Request) message.

Further, the UE 202 initiates a predefined timer corresponding to T3510. At operation 1120, the UE 202 receives the rejection of the registration from the network 206 in a registration reject 5GMM cause: #78—“PLMN not allowed to operate at the present UE location” message. Thereafter, at operation 1122, the UE 202 receive Radio Resource Control (RRC) release from the PLMN1 NG-RAN Satellite-NTN 204.

Further, at operation 1124, the UE 202 adds the PLMN1 204 to the list of the PLMNs not allowed to operate at the present location of the UE 202. Thereafter, the UE 202 stops the predefined timer.

At operation 1130, the UE 202 establishes the 5GMM deregistered PLMN search. Thereafter, at operation 1132, the UE 202 receive a connection request for a Packet Data Unit (PDU) for the one or more emergency services, when the user dials the emergency call. Thereafter, at operation 1134, the UE 202 considers the PLMN1 in the list of PLMNs not allowed to operate in the current location of the UE 202 as available for the emergency services.

At operation 1136, the UE 202 camps on the NG-RAN satellite cell for the one or more emergency services. Thereafter, at 1138, the UE 202 establishes the 5GMM deregistered limited service state. Now, at operations 1140 and 1142, the UE 202 transmits the registration request in RRCConnectionSetupComplete (Registration Request) with type as Emergency message to the network 206 via the PLMN1 NG-RAN-Satellite-NTN 204.

At operation 1142, the UE 202 may receive acceptance of the registration in a Registration accept message from the network 206.

At operation 1144, the UE 202 establishes the 5GMM registered limited service. Lastly, at operation 1146, the UE 202 connects with the one or more emergency services for the emergency call.

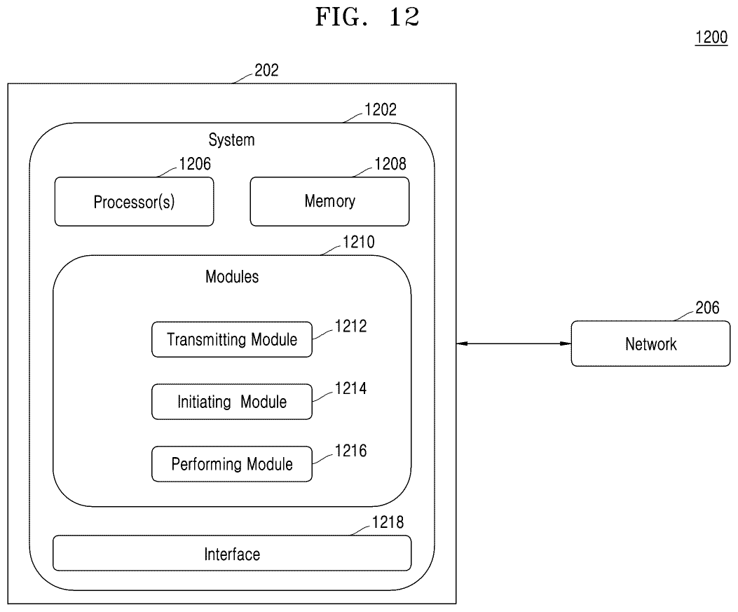

FIG. 12 illustrates a block diagram 1200 of a system 1004 configured for maintaining N1 Non-Access Stratum (NAS) signalling connection at the UE 202 supporting the one or more emergency services from the network 206, in accordance with an embodiment of the present disclosure.

In an embodiment, the system 1202 may be implemented within the UE 202. In another embodiment, the system 1202 may be in communication with the UE 202. The system 1202 may include at least one processor 1206 (in short, “the processor 1206”), a memory 1208, one or more modules 1210 (in short, “the modules 1210”), and an interface 1218. The processor 1206 may be in communication with the memory 1208, the modules 1210, and the interface 1218. The constructional and operational features of the processor 1206, the memory 1208, modules 1210, and the interface 1218 may be the same as the processor 1006, the memory 1008, modules 1010, and the interface 1018. Thus, the same has not been explained for the sake of brevity. Herein, the modules 1210 may include a transmitting module 1212, an initiating module 1214, and a performing module 1216.

In an embodiment, the transmitting module 1212 may be configured to transmit a registration request for a second network slice associated with the network 206. The transmitting module 1212 may be configured to transmit the registration request while the UE 202 may be registered with a first network slice with an established regular PDU (may be interchangeably referred here as the established regular/normal PDU) providing the one or more regular services and the established emergency PDU. The transmitting module 1212 may be configured to transmit the registration request for the second “network slice” in a ‘Registration Request message Requested Network Slice Selection Assistance Information (NSSAI): the first network slice and the second network slice.’

In response to transmitting the registration request, the initiating module 1214 may be configured to initiate the predefined timer.

Further, the performing module 1216 may be configured to maintain the N1 NAS signalling connection between the UE 202 and the network 206. The performing module 1216 may be configured to maintain the N1 NAS signal in response to an expiry of the predefined timer and no response from the network 206 for the transmitted registration request. Alternatively, the performing module 1216 may be configured to encode an uplink data status to indicate an active status of the established emergency PDU in the registration request.

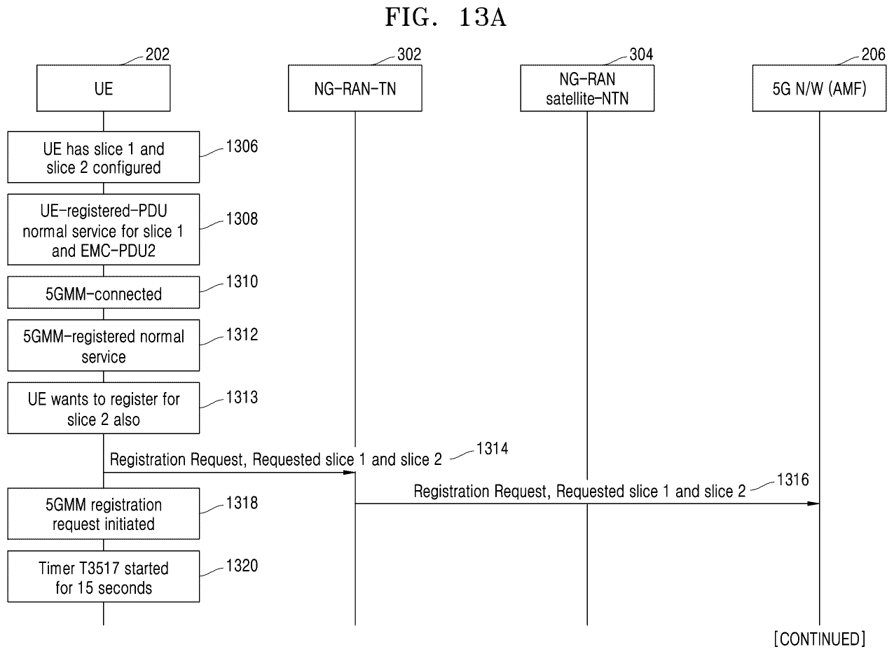

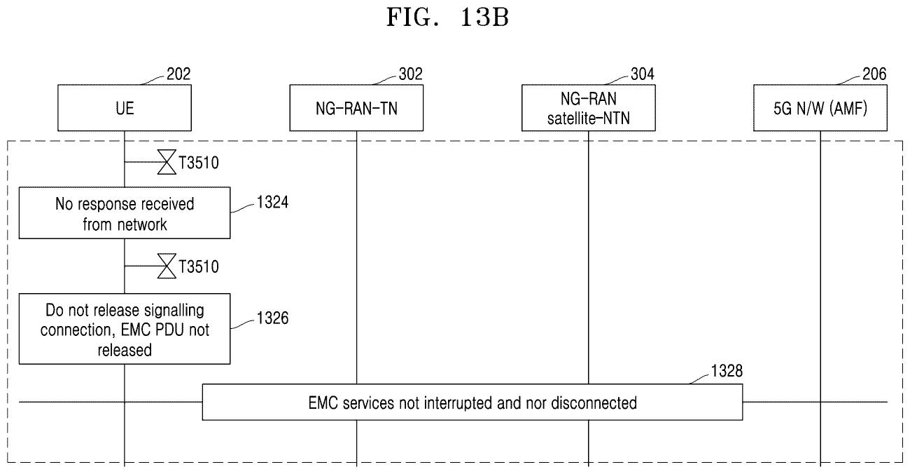

FIGS. 13A and 13B illustrate a sequence flow diagram associated with maintaining the N1 NAS signalling connection between the UE 202 and the network 206 by the system 1202, in accordance with an embodiment of the present disclosure.

In an embodiment, at operation 1306, the UE 202 may be registered for the first network slice and may be configured for the network slice 2 (second network slice).

At operation 1308, the UE 202 may include the established regular/normal PDU providing the one or more normal/regular services and the established emergency PDU for the emergency services.

At operation 1310, the UE 202 may be connected with the network 206 in a 5GMM-connected message. At operation 1312, the UE 202 may be registered for the one or more regular services in the 5GMM-registered normal service message. Further, at operation 1313, the UE 202 may also want to register for the network slice 2.

At operations 1314 and 1316, the UE 202 transmits the registration request (mobility registration) with the network slice 1 and the network slice 2 to the network 206 via NG-RAN-TN 302 or NG-RAN satellite-NTN 1302. The UE 202 may transmit the registration request in a Registration Request, Requested slice with the network slice 1 and the network slice 2, i.e., ‘Registration Request message NSSAI: the first network slice and the second network slice.’

At operation 1318, the UE 202 may initiate a process of connecting to the network 206 in the 5GMM registration request message. At operation 1320, the UE 202 may initiate the predefined timer of 15 seconds, when the UE 202 access the NG-RAN-TN 302 or 27 seconds when the UE 202 access the NG-RAN satellite-NTN 304.

At operation 1324, the UE 202 may receive no response from the network 206. Further, the predefined timer is continued.

At operation 1326, the UE 202 may not release the N1 NAS signalling connection on the expiry of the predefined timer. Therefore, at operation 1328, any ongoing emergency services on the UE 202 may not be interrupted and disconnected. Therefore, the UE 202 remains connected to the network.

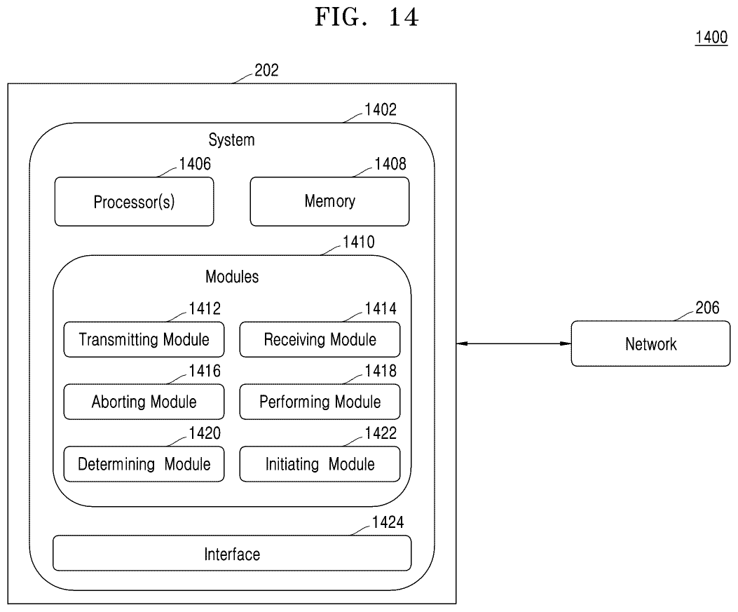

FIG. 14 illustrates a block diagram 1400 of a system 1402 configured for providing the one or more emergency services or emergency service fallback at the UE 202, in accordance with an embodiment of the present disclosure.

In an embodiment, the system 1402 may be implemented within the UE 202. In another embodiment, the system 1402 may be in communication with the UE 202. The system 1402 may include at least one processor 1406 (referred to herein as the processor 1406), a memory 1408, one or more modules 1410 (referred to herein as the modules), and an interface 1424. The processor 1406 may be in communication with the memory 1408, the modules 1410, and the interface 1424. The constructional and operational features of the processor 1406, the memory 1408, modules 1410, and the interface 1424 may be the same as the processor 1006, the memory 1008, modules 1010, and the interface 1018. Thus, the same has not been explained for the sake of brevity. Herein, the modules 1410 may include a transmitting module 1412, a receiving module 1414, an aborting module 1416, a performing module 1418, a determining module 1420, and an initiating module 1422.

In an embodiment, the transmitting module 1412 may be configured to transmit a first signalling request to access the one or more regular services. The transmitting module 1412 may be configured to transmit the first signalling request to the network 206 via one of a 3rd Generation Partnership Project (3GPP) access and a non-3GPP access.

In such an embodiment, the transmitting module 1412 may transmit a service request with a status of the uplink data for the established regular PDU on one of the 3GPP access and the non-3GPP access. Thereafter, the initiating module 1422 may be configured to initiate the predefined timer.

Alternatively, the transmitting module 1412 may be configured to transmit a registration request procedure on the one of the 3GPP access and the non-3GPP access for a reason. The reason may be other than emergency services or emergency services fallback or initiating a PDU connection for emergency bearer services or moving out of registration area or due to Inter RAT Change or due to capability update and initiating the predefined timer. In yet another embodiment, the transmitting module 1412 may be configured to transmit any other request or request procedure on the one of the 3GPP access and the non-3GPP access, without departing from the scope of the present disclosure.

The receiving module 1414 may be configured to receive at least one of a request to access the one or more emergency services and the emergency service fallback request while the UE 202 may be waiting for a response for the first signalling request. The receiving module 1414 may be configured to receive the at least one of the request from the one or more applications associated with the UE 202.

In an embodiment, upon receiving the at least one of the request to access the one or more emergency services and the emergency service fallback request, the transmitting module 1412 along with the aborting module 1416 may be configured to perform one of the following operations as discussed in the subsequent paragraphs.

The aborting module 1416 may be configured to abort a first signalling procedure, upon receiving the at least one of the request to access the one or more emergency services and the emergency service fallback request.

In such an embodiment, in response to aborting the first signalling request procedure, the performing module 1418 may be configured to release a signalling connection associated with the transmitted first signalling request and stopping the initiated predefined timer. Further, the performing module 1418 may be configured to determine whether a Radio Access Technology (RAT) of PLMN selection is required. Further, when the determining module 1420 may determine that the RAT or PLMN selection is not required, then in response to determining that the RAT or PLMN selection is not required, the transmitting module 1412 may be configured to transmit the second signalling request on the current RAT.

Further, in response to determining that the RAT or PLMN selection is required, the transmitting module 1412 may be configured to select another RAT or PLMN combination and transmit the second signalling request on the selected another RAT or PLMN combination.

The transmitting module 1412 may be configured to transmit at least one of a second signalling request to access the one or more emergency services and the emergency service fallback request. The transmitting module 1412 may be configured to transmit at least one of the second signalling request to the network 206.

In such an embodiment, the initiating module 1422 may be configured to initiate one of a service request procedure and a registration request procedure on the UE for the one or more emergency services or emergency service fallback request on the selected another RAT or PLMN combination.

Further, alternatively, the transmitting module 1412 may be configured to transmit, to the network 206, at least one of the second signalling request to access the one or more emergency services and the emergency service fallback request in parallel to the first signalling request.

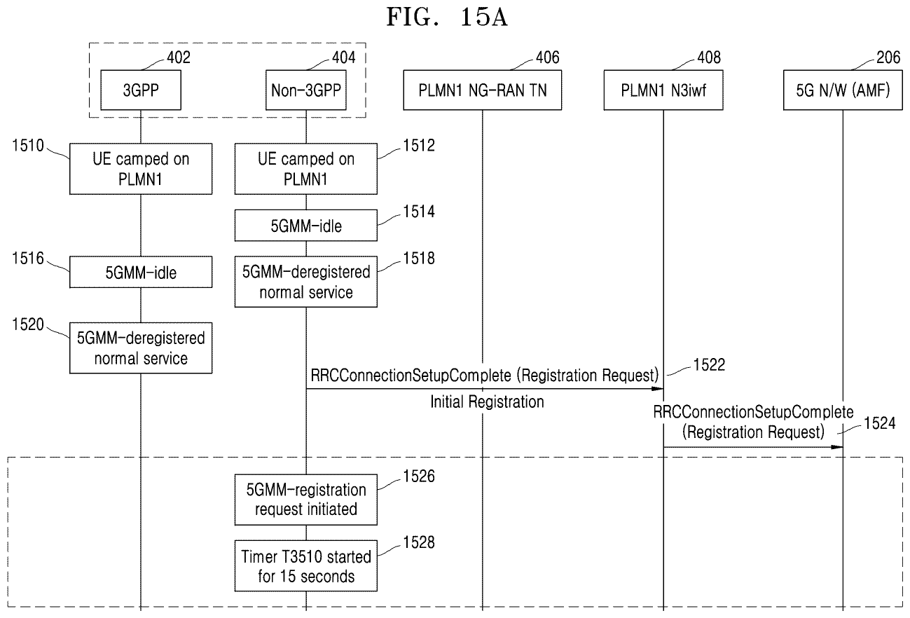

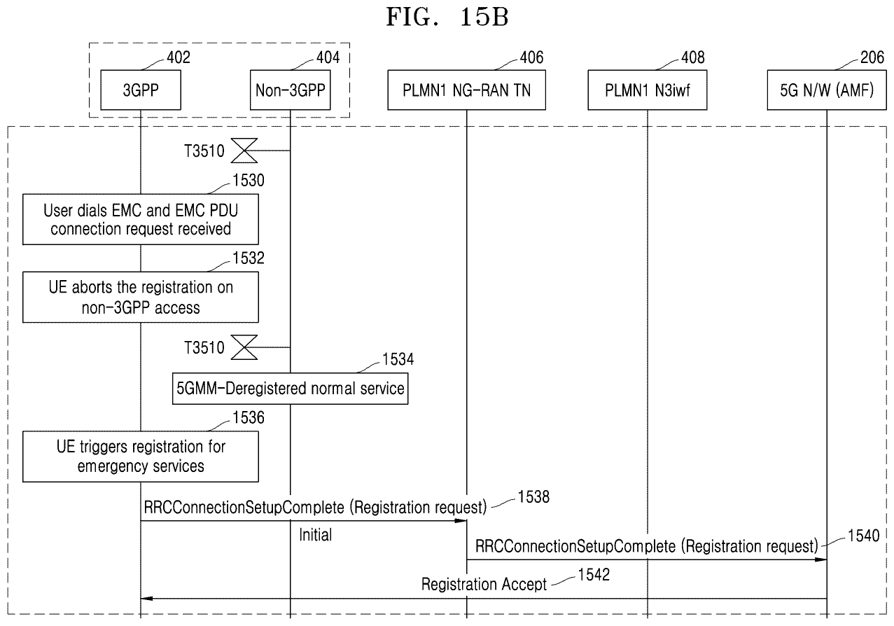

FIGS. 15A and 15B illustrate a sequence flow diagram for providing the one or more emergency services at the UE 202 on a 3rd Generation Partnership Project (3GPP) access, in accordance with an embodiment of the present disclosure.

At operations 1510 and 1512, the UE 202 may camp on each of the 3rd Generation Partnership Project (3GPP) access and the non-3GPP access on same PLMN.

At operation 1514, the UE 202 may be connected to the network 206 but is in the idle state at the non-3GPP access.

At operation 1516, the UE 202 may be connected to the network 206 but is in the idle state on the 3GPP access 402. At operation 1518, the UE 202 may deregister the one or more normal service/regular services in the 5GMM-deregistered normal service message on the non-3GPP access 404.

At operation 1520, the UE 202 may deregister the one or more normal service/regular services in the 5GMM-deregistered normal service message on the 3GPP access 402.

At operations 1522 and 1524, the UE 202 may transmit a registration request, on the non-3GPP access 404 associated with a Public Land Mobile Network (PLMN), to the network 206 via PLMN1 NG-RAN TN 406 and PLMN1 N3iwf 408 in the RRCConnectionSetupComplete (Registration Request) message.

At operation 1526, the UE 202 may initiate a registration on the non-3GPP access 404. Thereafter, at operation 1528, the UE 202 may initiate the predefined timer, from the T3510, of 15 seconds on non-3GPP access 404.

Further, at operation 1530, the UE 202 may receive the connection request of the established emergency PDU for the emergency services on the 3GPP access 402, when the user dials the emergency service.

At operation 1532, the UE 202 may abort the ongoing registration of the non-3GPP access 404 and thereafter, stop the predefined timer on the non-3GPP access 404.

At operation 1534, the UE 202 may deregister the one or more normal service/regular services in the 5GMM-deregistered normal service message on the non-3GPP access 404.

Thereafter, at operations 1536, 1538, and 1540, the UE 202 may trigger/initiate the registration for the one or more emergency services in a RRCConnectionSetupComplete (Registration request) Initial message.

Lastly, at operation 1542, the UE 202 may receive acceptance of registration from the network 206, thereby establishing the one or more emergency services on the 3GPP.

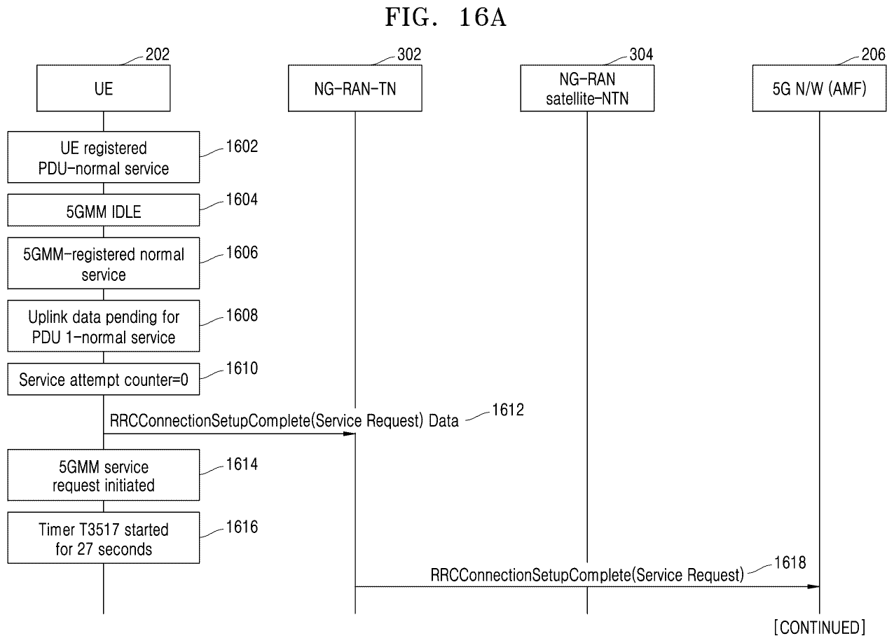

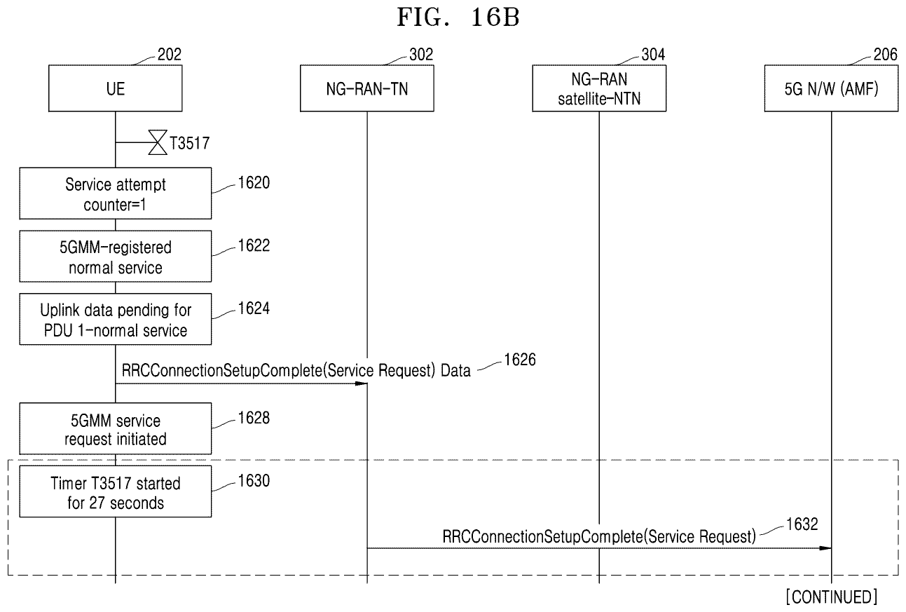

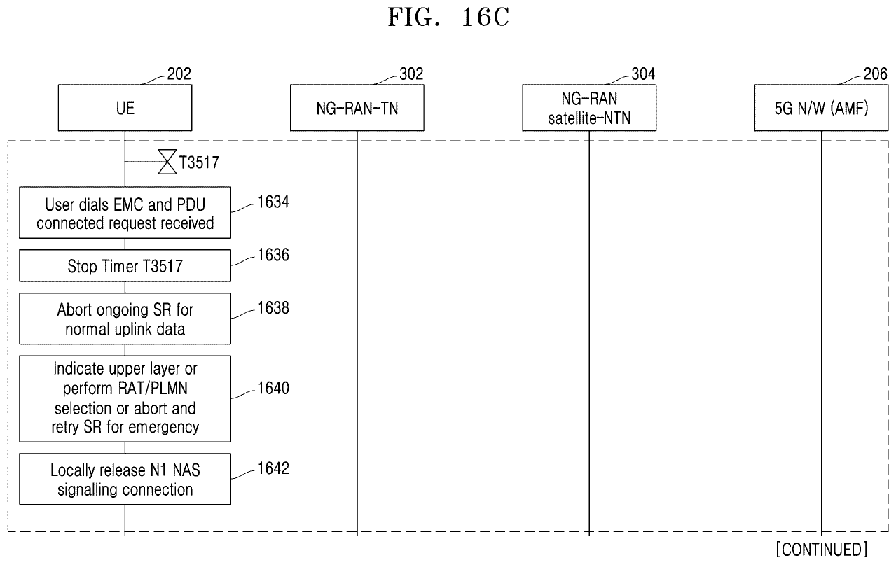

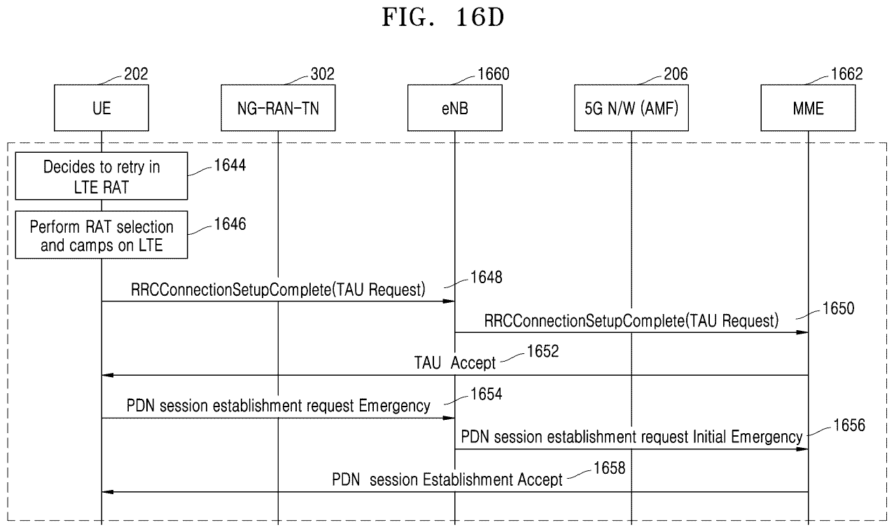

FIGS. 16A, 16B, 16C, and 16D illustrates a sequence flow diagram for establishing the connection of the one or more emergency services at the UE 202, when the UE 202 includes the established regular PDU in case of the NG-RAN-TN 302, in accordance with an embodiment of the present disclosure.

At operation 1602, the UE 202 may be registered with the network 206. Further, the UE 202 may include the established regular PDU for the one or more regular services.

At operation 1604, the UE 202 may be in the idle state indicated by the 5GMM idle message.

At operation 1606, the UE 202 may register for the one or more regular services and in the 5GMM-registered normal service state.

At operation 1608, the one or more applications correspond to a regular PDU that triggers data transactions, and the UE 202 may process the uplink data pending for the established regular PDU.

At operation 1610, the UE 202 may monitor a service attempt counter as 0.

At operation 1612, the UE 202 may transmit a service request to the NG-RAN-TN 302 in the RRCConnectionSetupComplete (service request) data message.

At operation 1614, the UE 202 may initiate the service request in the 5GMM service request message.

At operation 1616, the UE 202 may initiate the predefined timer, i.e., 15 seconds from Timer T3517.

At operation 1618, the NG-RAN-TN 302 may transmit the service request to the network 206 in the RRCConnectionSetupComplete (service request) message.

Further, the predefined timer is continued and at operation 1620, the UE 202 may monitor the service attempt counter as 1. Thereafter, at operation 1622, the UE 202 may register the one or more regular services and in the 5GMM registered normal service state.

At operation 1624, the UE 202 may process the uplink data pending for the established regular PDU.

At operation 1626, the UE 202 may transmit a service request for the uplink data to the NG-RAN-TN 302 in the RRCConnectionSetupComplete (service request) data message.

At operation 1628, the UE 202 may initiate the service request in the 5GMM service request message.

At operation 1630, the UE 202 may initiate the predefined timer, i.e., 15 seconds from Timer T3517.

At operation 1632, the NG-RAN-TN 302 may transmit the service request to the network 206 in the RRCConnectionSetupComplete (service request) message.

Further, the predefined timer is continued, and at operation 1634, the UE 202 may receive the emergency PDU connection request when the user dials emergency call.

At operation 1636, the UE 202 may stop the predefined timer.

At operation 1638, the UE 202 may abort the ongoing service request for the uplink data for the normal PDU. Thereafter, at operation 1640, the UE 202 may indicate the upper layer or perform a selection of PLMN/RAT or abort and retry the service request for the one or more emergency services. Particularly, the UE 202 may select another RAT and retry the service request for the uplink service pending for the emergency PDU.

At operation 1642, the UE 202 may locally release the N1 NAS signalling connection. Thereafter, at operation 1644, the UE 202 may decide to retry the service request for the one or more emergency services in the LTE RAT. Particularly, the UE 202 may retry the service request for the uplink service pending for the emergency PDU in the another RAT.

At operations 1648 and 1650, the UE 202 may initiate Tracking Area Update (TAU) request to Mobility Management Entity (MME) 1662 via Evolved Node B (eNB) 1660 based on camping on the LTE. The UE 202 may initiate TAU in RRCConnectionSetupComplete (TAU Request) message.

At operation 1652, the UE 202 may receive acceptance of the TAU from the MME 1662.

At operation 1654, the UE 202 may transmit Packet Data Network (PDN) session establishment request in the PDN session establishment request initial emergency message to the eNB 1660. Further, at operation 1656, the eNB 1656 may transmit the PDN session establishment request in the PDN session establishment request initial emergency message.

At operation 1658, the UE 202 accepts and establishes the PDN session as received from the MME 1662.

In an embodiment, the same operation may be implemented for the NG-RAN-NTN 304, without departing from the scope of the present disclosure.

In an embodiment, the same operation may be implemented for the NG-RAN-NTN 304, without departing from the scope of the present disclosure.

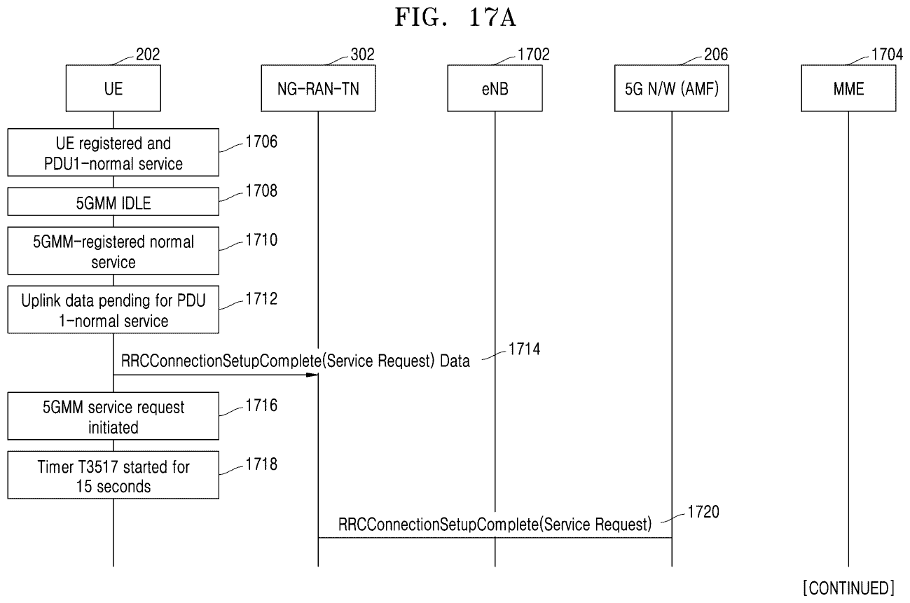

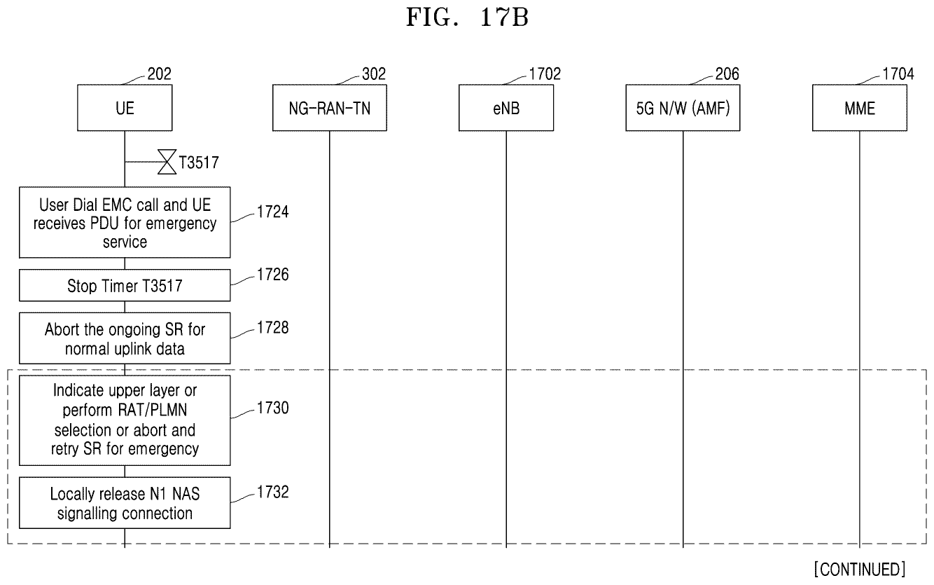

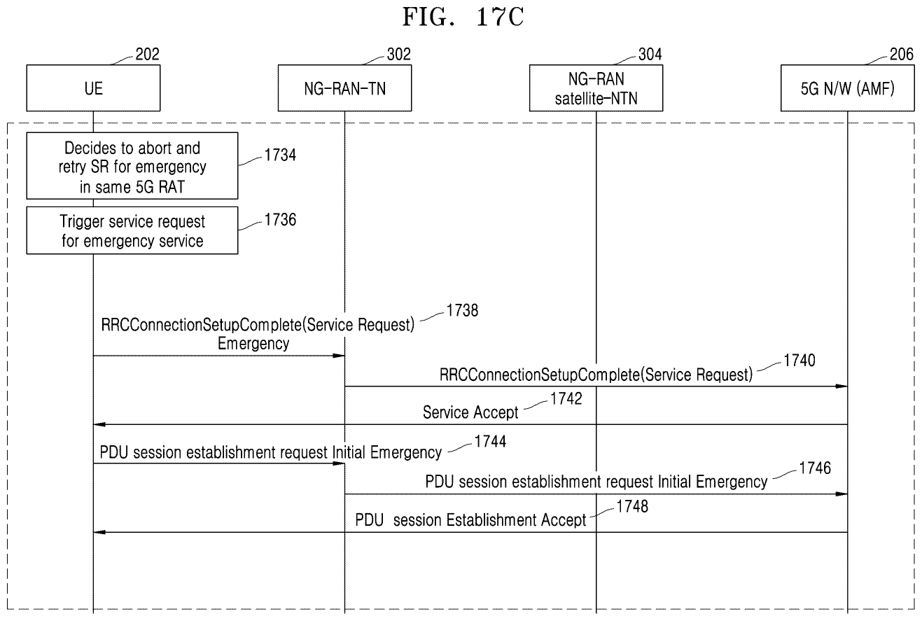

FIGS. 17A, 17B, and 17C illustrate a sequence flow diagram for establishing the connection of the one or more emergency services at the UE 202, when the UE 202 includes the established regular PDU in case of eNB 1702, in accordance with an embodiment of the present disclosure.

At operation 1706, the UE 202 may be registered with the network 206. Further, the UE 202 may include the established regular PDU for the one or more regular services.

At operation 1708, the UE 202 may be in the idle state indicated by the 5GMM idle message.

At operation 1710, the UE 202 may register for the one or more regular services and in the 5GMM-registered normal service state.

At operation 1712, the one or more applications correspond to a regular PDU that triggers data transactions, and the UE 202 may process the uplink data pending for the established regular PDU.

At operation 1714, the UE 202 may transmit a service request related to the uplink data to the NG-RAN satellite-TN 302 in the RRCConnectionSetupComplete (service request) data message.

At operation 1716, the UE 202 may initiate the service request in the 5GMM service request message.

At operation 1718, the UE 202 may initiate the predefined timer, i.e., 15 seconds from Timer T3517.

At operation 1720, the NG-RAN-TN 302 may transmit the service request to the network 206 in the RRCConnectionSetupComplete (service request) message.

Further, the predefined timer is continued and at operation 1724, the UE 202 receives the emergency PDU connection request when the user dials emergency call.

At operation 1726, the UE 202 stops the predefined timer.

At operation 1728, the UE abort the ongoing service request for the uplink data for the one or more regular services. Thereafter, at operation 1730, the UE 202 may indicate the upper later or perform the selection of the RAT/PLMN or abort and retry the service request for the emergency.

At operation 1732, the UE 202 may locally release the N1 NAS signalling connection. Thereafter, at operation 1734, the UE 202 may decide to abort and retry the service request for the one or more emergency services in the same 5G RAT. At operations 1736, 1738, and 1740, the UE 202 may trigger the service request for the one or more emergency services in the RRCConnectionSetupComplete (Service Request) message.

At operation 1742, the UE 202 may receive service acceptance from the network 206.

At operation 1744, the UE 202 transmits the request for the PDU session establishment in the PDU session establishment request initial emergency message to the NG-RAN-TN 302. Further, at operation 1746, the NG-RAN-TN 302 transmits the request for the PDU session establishment in the PDU session establishment request initial emergency message to the network 206.

At operation 1748, the UE 202 accepts and establishes the PDU session for the one or more emergency service as received from the network 206.

In an embodiment, the same operation may be implemented for the NG-RAN-NTN 304, without departing from the scope of the present disclosure.

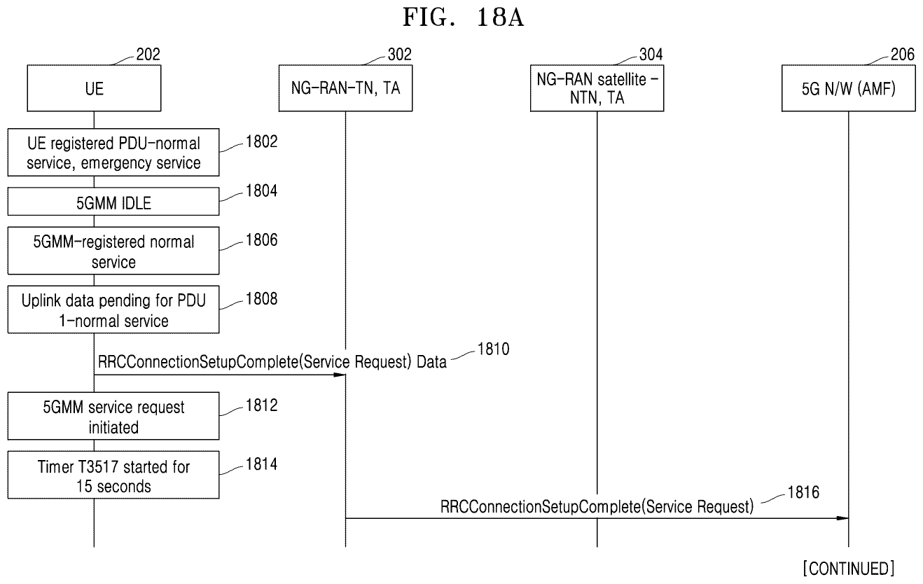

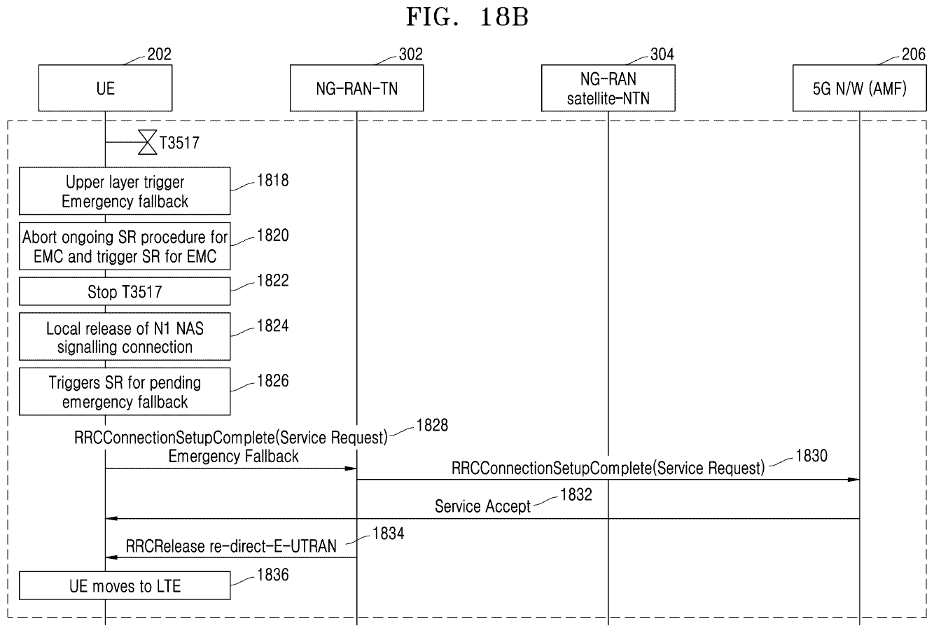

FIGS. 18A and 18B illustrate a sequence flow diagram for providing the emergency fallback service request, in accordance with an embodiment of the present disclosure.

At operation 1802, the UE 202 may be registered on the network 206. Further, the UE 202 includes the established regular PDU (PDU1) for the one or more regular services and the established emergency PDU (PDU2) for the one or more emergency services.

At operation 1804, the UE 202 may be in the idle state indicated by the 5GMM idle message.

At operation 1806, the UE 202 may register for the one or more regular services in the 5GMM-registered normal service message.

At operation 1808, the one or more applications correspond to a regular PDU that triggers data transactions, and the UE 202 processes the uplink data pending for the established regular PDU for the one or more regular services.

At operation 1810, the UE 202 transmits a service request related to the uplink data to the NG-RAN-TN 302 in the RRCConnectionSetupComplete (service request) data message.

At operation 1812, the UE 202 may initiate the service request for the one or more regular services in the 5GMM service request message.

At operation 1814, the UE 202 may initiate the predefined timer, i.e., 15 seconds from the Timer T3517.

At operation 1816, the NG-RAN-TN 302 transmits the service request to the network 206 in the RRCConnectionSetupComplete message.

Further, the predefined timer is continued and at operation 1818, the UE 202, specifically an upper layer of the UE 202 triggers emergency fallback.

At operation 1820, the UE 202 may abort the ongoing service request for the one or more regular services and trigger the service request of the one or more emergency services.

At operation 1822, the UE 202 may stop the predefined timer.

At operation 1824, the UE 202 may locally release the N1 NAS signalling connection.

At operation 1826, the UE 202 determines to continue with current RAT and PLMN, and the UE 202 may initiate a service request for pending emergency fallback.

At operation 1828, the UE 202 may transmit the service request to the NG-RAN-TN 302 in the RRCConnectionSetupComplete (Type as Emergency Fallback) message. Thereafter, at operation 1830, the NG-RAN-TN 302 may transmit the service request to the network 206 in the RRCConnectionSetupComplete (service request) message.

At operation 1832, the UE 202 may receive the acceptance of the service from the network 206.

At operation 1834, the UE 202 may receive the RRC release redirect-E-UTRAN from the NG-RAN-TN 302. Further, at operation 1836, the UE 202 moves to the LTE and establish the PDU for the emergency services.

In another embodiment, the operations as disclosed above may be also implemented in NTN scenario where the predefined timer may be of 27 seconds to trigger SR for Emergency service fallback.

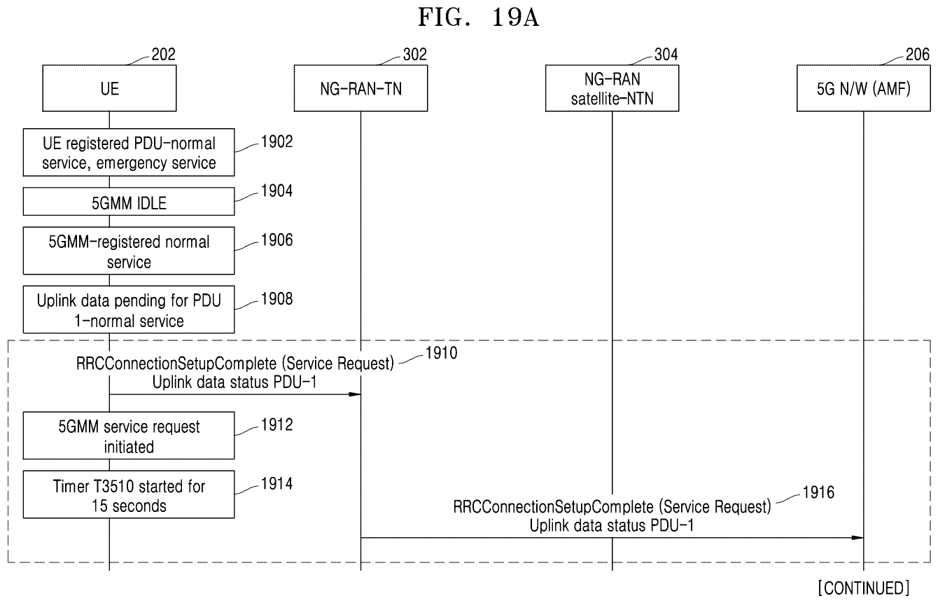

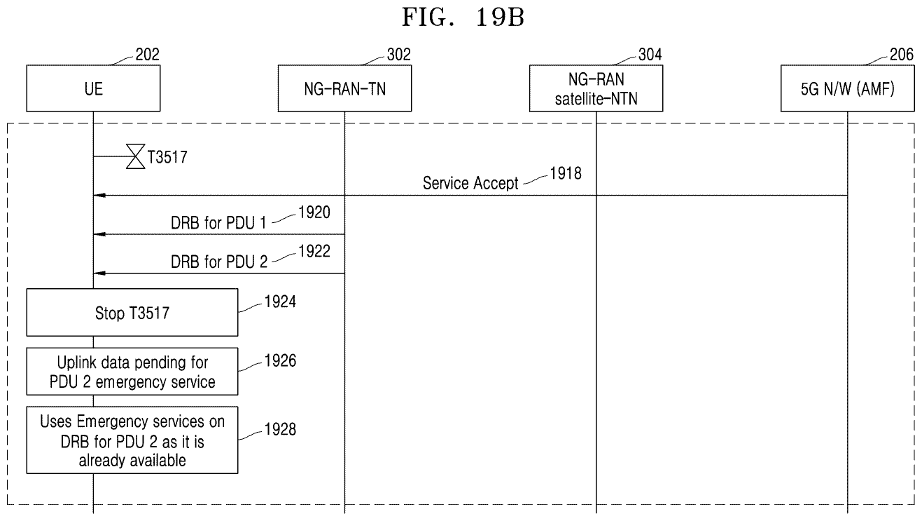

FIGS. 19A and 19B illustrate a sequence flow diagram for establishing the one or more emergency services at the UE 202, when the UE 202 receives a Data Radio Bearer (DRB) for each of the established regular PDU and the established emergency PDU, in accordance with an embodiment of the present disclosure.

At operation 1902, the UE 202 may be registered on the network 206. Further, the UE 202 includes the established regular PDU (PDU1) for the one or more regular services and the established emergency PDU (PDU2) for the emergency services.

At operation 1904, the UE 202 may be in the idle state indicated by the 5GMM idle message.

At operation 1906, the UE 202 may register for the one or more regular services in the 5GMM-registered normal service message.

At operation 1908, the one or more applications correspond to a regular PDU that triggers data transactions, and the UE 202 may process the uplink data pending for the established regular PDU. Herein, a status of the uplink data for both the established regular PDU (PDU1) and the established emergency PDU (PDU2) may be 1.

At operation 1910, the UE 202 transmits a service request related to the uplink data to the NG-RAN-TN 302 in the RRCConnectionSetupComplete (service request) uplink data status PDU1 message.

At operation 1912, the UE 202 may initiate the service request in the 5GMM service request message.

At operation 1914, the UE 202 may initiate the predefined timer, i.e., 15 seconds from the Timer T3517.

At operation 1916, the NG-RAN-TN 302 transmits the service request to the network 206 in the RRCConnectionSetupComplete (service request) uplink data status PDU1 message.

Further, the predefined timer is continued and at operation 1918, the UE 202 received the acceptance of the service from the network 206.

At operations 1920 and 1922, the UE 202 may receive the DRB for each of the established regular PDU (PDU1) and the established emergency PDU (PDU2).

At operation 1924, the UE 202 may stop the predefined timer.

At operation 1926, the UE 202 may process the uplink data pending for the established emergency PDU (PDU2). Thereafter, at operation 1928, the UE 202 may proceed with emergency service on the DRB for the established emergency PDU (PDU2) as the DRB is already available, thereby establishing the one or more emergency services at the UE 202 at the earliest.

In another embodiment, the operations as disclosed above may be also implemented in NTN scenario where the predefined timer may be of 27 seconds to trigger SR for Emergency service fallback.

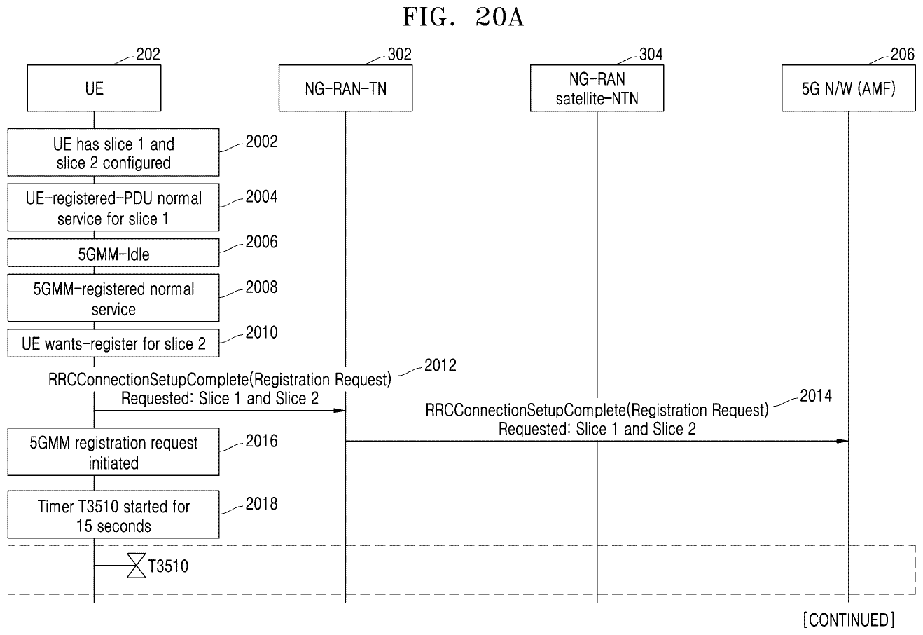

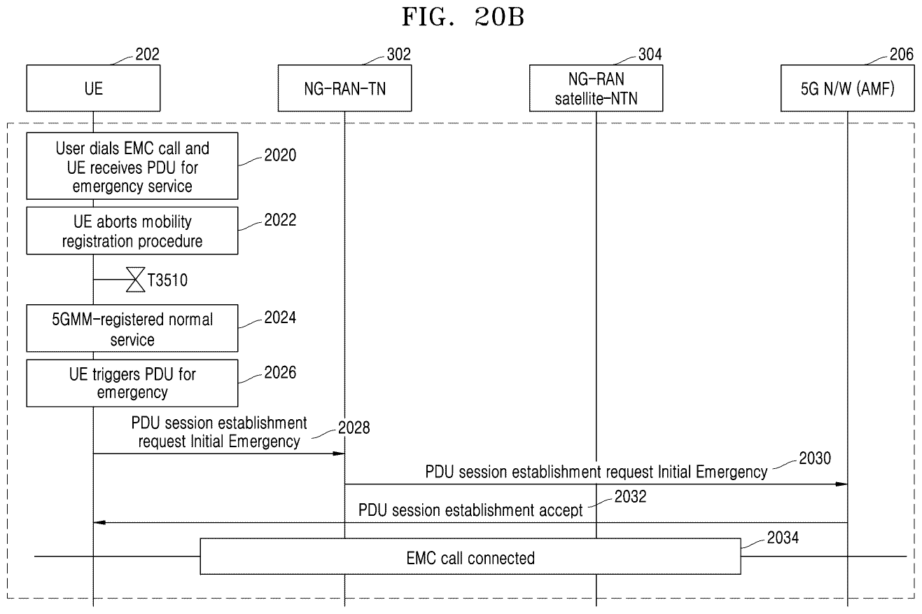

FIGS. 20A and 20B illustrates a sequence flow diagram for establishing connection of the one or more emergency services at the UE 202, when the UE 202 is registered for the network slice 1 and is configured for the network slice 2, in accordance with an embodiment of the present disclosure.

Herein, at operation 2002, the UE 202 may be registered with the network slice 1 (first network slice) and is configured for the network slice 2 (second network slice).

At operation 2004, the UE 202 has the PDU for the regular services, specifically, for the network slice 1.

At operation 2006, the UE 202 may be connected with the network 206 and is in the idle state. At operations 2008 and 2010, the UE 202 may be registered for the one or more regular services in the 5GMM-registered normal service message and also wants to register for the network slice 2.

At operations 2012 and 2014, the UE 202 may transmit the registration request (mobility registration) with the network slice 1 and the network slice 2 to the network 206 via the NG-RAN-TN 302 or the NG-RAN satellite-NTN 304. The UE 202 transmits the registration request in a RRCConnectionSetupComplete (Registration Request) Requested slice: Slice 1 and Slice 2 message.

At operation 2016, the UE 202 may initiate the registration request in the 5GMM registration request message and at operation 2018, the UE 202 initiates the predefined timer of 15 seconds.

Further, the predefined timer is continued and at operation 2020, the UE 202 may receive the emergency PDU for the one or more emergency services when the user dials emergency calls.

At operation 2022, the UE 202 may abort the ongoing mobility registration, and thereafter stop the predefined timer.

At operation 2024, the UE 202 may register the one or more regular services in the 5GMM-registered normal service message. Thereafter, at operation 2026, the UE 202 may initiate the emergency PDU for the one or more emergency services. At operations 2028, 2030, the UE 202 may transmit the request for the PDU establishment session to the network 206 in the PDU session establishment request Initial Emergency message. Further, at operation 2032, the PDU session is established between the UE 202 and the network 206 in a PDU session establishment accept message 932. Thereafter, at operation 2034, the UE 202 may be connected to the one or more emergency calls.

In another embodiment, the operations as disclosed above may be also implemented in NTN scenario where the predefined timer may be of 27 seconds.

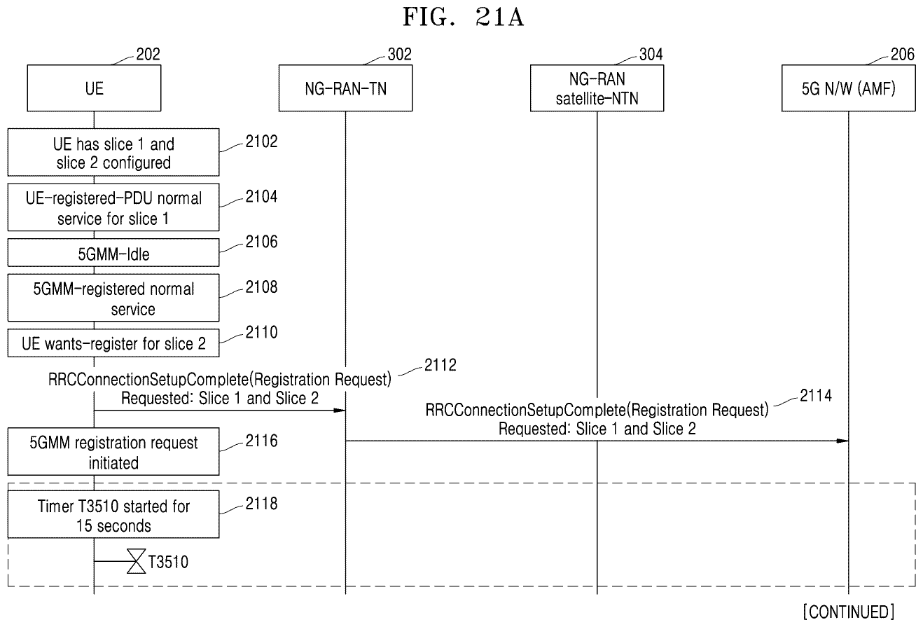

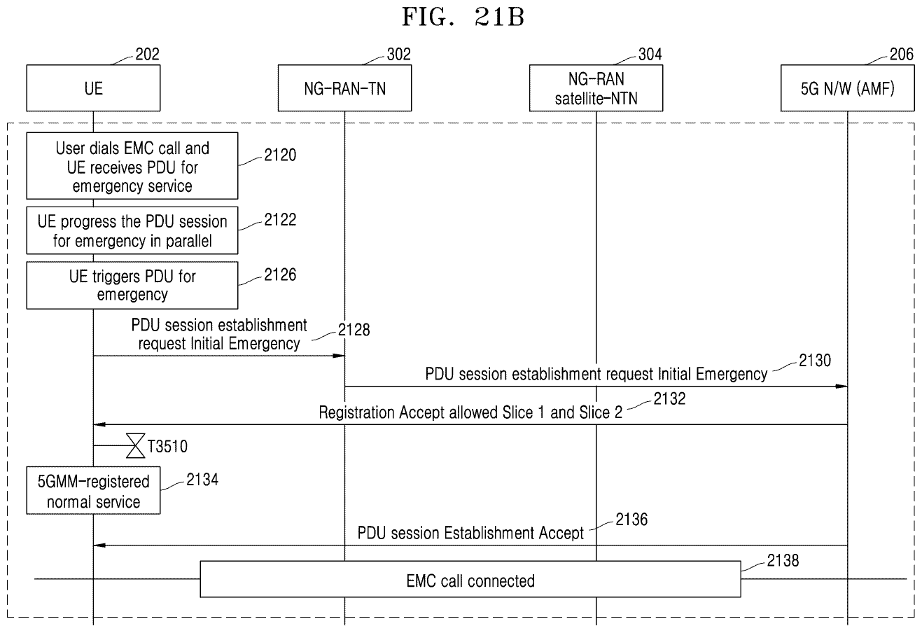

FIGS. 21A and 21B illustrate a sequence flow diagram for establishing connection of the one or more emergency services at the UE 202, when the UE 202 is registered for the network slice 1 and is configured for the network slice 2, in accordance with another embodiment of the present disclosure.

Herein, at operation 2102, the UE 202 may be registered with the network slice 1 (first network slice) and is configured for the network slice 2 (second network slice).

At operation 2104, the UE 202 has the PDU for the regular services, specifically, for the network slice 1.

At operation 2106, the UE 202 may be connected with the network 206 and is in the idle state. At operations 2108 and 2110, the UE 202 may be registered for the one or more regular services in the 5GMM-registered normal service message and also wants to register for the network slice 2.

At operations 2112 and 2114, the UE 202 may transmit the registration request (mobility registration) with the network slice 1 and the network slice 2 to the network 206 via the NG-RAN-TN 302 or the NG-RAN satellite-NTN 304. The UE 202 transmits the registration request in a RRCConnectionSetupComplete (Registration Request) Requested: Slice 1 and Slice 2 message.

At operation 2116, the UE 202 may initiate the registration request in the 5GMM registration request message and at operation 2118, the UE 202 initiates the predefined timer of 15 seconds.

Further, the predefined timer is continued and at operation 2120, the UE 202 may receive the emergency PDU for the one or more emergency services when the user dials emergency calls.

At operation 2122, the UE 202 may progress/process the emergency PDU in parallel with the mobility registration.

Thereafter, at operation 2126, the UE 202 may initiate the emergency PDU for the one or more emergency services. At operations 2128, 2130, the UE 202 may transmit the request for the PDU establishment session to the network 206 in the PDU session establishment request Initial Emergency message. Further, at operation 2132, the UE 202 may receive the acceptance of the registration for the network slice 1 and the network slice 2 in a Registration Accept allowed Slice 1 and Slice 2 message. Thereafter, the UE 202 may stop the predefined timer. Further, at operation 2134, the UE may register the one or more regular services in the 5GMM-registered normal service message.

Further, at operation 2136, the PDU session is established between the UE 202 and the network 206 in a PDU session establishment accept message. Thereafter, at operation 2138, the UE 202 may be connected to the one or more emergency services.

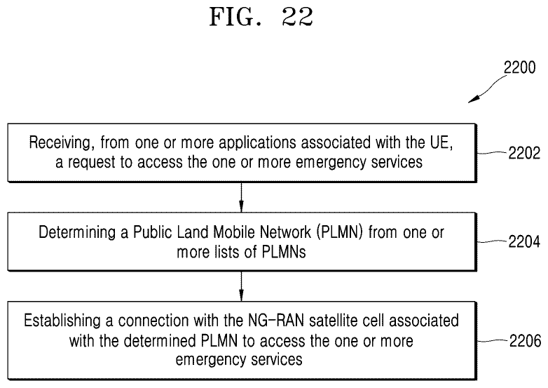

The method 2200 includes a series of operations shown at operation 2202 through operation 2206 of FIG. 22. The method 2200 may be performed by the system 1004 in conjunction with modules 1010, the details of which are explained in conjunction with FIGS. 10B to 11B, and the same are not repeated here for the sake of brevity in the present disclosure. The method 2200 begins at operation 2202.

At operation 2202, the method 2200 includes receiving, from the one or more applications associated with the UE 202, the request to access the one or more emergency services. The one or more applications corresponds to different types of emergency applications.

At operation 2204, the method 2200 includes determining the Public Land Mobile Network (PLMN) from one or more lists of PLMNs. The one or more lists of PLMNs may include at least the list of PLMNs not allowed to operate in a current location of the UE 202. The one or more lists of PLMNs may include one or more lists of forbidden PLMNs other than the list of PLMN not allowed to operate in the current location of the UE 202.

At operation 2206, the method 2200 includes establishing the connection with the NG-RAN satellite cell associated with the determined PLMN to access the one or more emergency services.

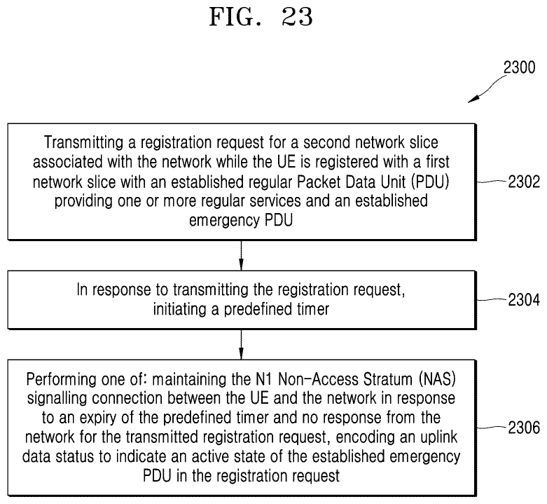

The method 2300 includes a series of operations shown at operation 2302 through operation 2306 of FIG. 23. The method 2300 may be performed by the system 1202 in conjunction with modules 1210, the details of which are explained in conjunction with FIGS. 12 to 13B, and the same are not repeated here for the sake of brevity in the present disclosure. The method 2300 begins at operation 2302.

At operation 2302, the method 2300 includes transmitting the registration request for the second network slice associated with the network 206 while the UE 202 is registered with the first network slice with the established regular Packet Data Unit (PDU) providing one or more regular services and the established emergency PDU, that is, the transmitting the registration request for the second network slice in the ‘Registration Request message Requested NSSAI: the first network slice and the second network slice.’

At operation 2304, the method 2300 includes in response to transmitting the registration request, initiating the predefined timer.

At operation 2306, the method 2300 includes performing maintaining the N1 Non-Access Stratum (NAS) signalling connection between the UE 202 and the network 206 in response to the expiry of the predefined timer and no response from the network 206 for the transmitted registration request. Alternatively, the method 2300 includes encoding the uplink data status to indicate the active state of the established emergency PDU in the registration request.

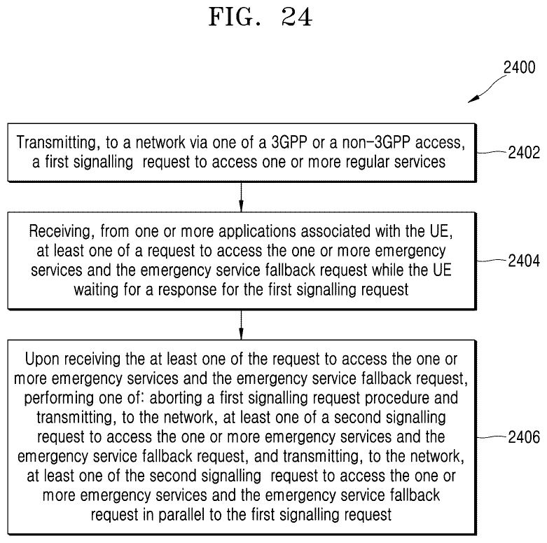

The method 2400 includes a series of operations shown at operation 2402 through operation 2406 of FIG. 24. The method 2400 may be performed by the system 1402 in conjunction with modules 1410, the details of which are explained in conjunction with FIGS. 15A to 21B, and the same are not repeated here for the sake of brevity in the present disclosure. The method 2400 begins at operation 2402.

At operation 2402, the method 2400 includes transmitting, to the network 206 via one of the 3GPP or the non-3GPP access, the first signalling request to access the one or more regular services.

The method 2400 includes transmitting a service request with a status of uplink data for an established regular PDU on one of the 3GPP access and the non-3GPP access and initiating a predefined timer.

The method 2400 includes transmitting the registration request procedure on the one of the 3GPP access and the non-3GPP access for the reason other than emergency services or emergency services fallback or initiating the PDU connection for emergency bearer services or moving out of registration area or due to Inter RAT Change or due to capability update and initiating the predefined timer.

At operation 2404, the method 2400 includes receiving, from the one or more applications associated with the UE, at least one of a request to access the one or more emergency services and the emergency service fallback request while the UE 202 is waiting for the response for the first signalling request.

Upon receiving the at least one of the request to access the one or more emergency services and the emergency service fallback request, at operation 2406, the method 2400 includes performing aborting the first signalling request procedure. Further, the method 2400 includes transmitting, to the network 206, at least one of the second signalling request to access the one or more emergency services and the emergency service fallback request. The method 2400 includes initiating one of the service request procedure and the registration request procedure on the UE 202 for the one or more emergency services or emergency service fallback request on the selected another RAT or PLMN combination.

Upon receiving the at least one of the request to access the one or more emergency services and the emergency service fallback request, at operation 2406, alternatively, the method 2400 includes performing transmitting, to the network, at least one of the second signalling request to access the one or more emergency services and the emergency service fallback request in parallel to the first signalling request.

The method 2400 includes performing, by the UE 202, one of releasing the signalling connection associated with the transmitted first signalling request and stopping the initiated predefined timer, or determining whether the Radio Access Technology (RAT) or PLMN selection is required. Further, in response to determining the RAT or PLMN selection is not required, the method 2400 includes transmitting the second signalling request on the current RAT. In response to determining the RAT selection is required, the method 2400 includes selecting another RAT or PLMN combination and transmitting the second signalling request on the selected another RAT or PLMN combination.

The technical advantage and the embodiments of the present disclosure may be summarized as: Service Request (SR) procedure in progress timer T3517 running on TN or NTN and EMC call is triggered:

If the EMC (Emergency) call is of type Emergency service, then: Abort the ongoing SR procedure for normal PDU service and trigger SR for uplink service pending for EMC; or When EMC PDU exists encode uplink data status for EMC PDU as 1 always in every SR.

If the EMC call is of type emergency service fallback, then: Abort the ongoing SR procedure for normal PDU service and trigger SR for emergency service fallback.

Thus, the systems and the methods as disclosed enables faster emergency services to the user when connected in NTN or TN (different RATs), also enables faster emergency services to the user between different the 3GPP access and the non-3GPP access. Further, the systems and the methods enable limited camping & emergency services in NTN only location

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

What is claimed is:

1. A method for handling one or more emergency services at a User Equipment (UE) via a New Generation-Radio Access Technology (NG-RAN) satellite cell, comprising:
receiving, from one or more applications associated with the UE, a request to access the one or more emergency services;
determining a Public Land Mobile Network (PLMN) from one or more lists of PLMNs, wherein the one or more lists of PLMNs comprises at least a list of PLMNs not allowed to operate in a current location of the UE; and
accessing the one or more emergency services by establishing a connection with the NG-RAN satellite cell associated with the determined PLMN.

2. The method of claim 1, wherein the one or more applications corresponds to different types of emergency applications.

3. The method of claim 1, wherein the one or more lists of PLMNs comprises one or more lists of forbidden PLMNs other than the list of PLMN not allowed to operate in the current location of the UE.

4. A method for maintaining N1 Non-Access Stratum (NAS) signalling connection at a User Equipment (UE) supporting one or more emergency services from a network, comprising:
transmitting a registration request for a second network slice associated with the network while the UE is registered with a first network slice with an established regular Packet Data Unit (PDU) providing one or more regular services and an established emergency PDU;
in response to transmitting the registration request, initiating a predefined timer; and
performing one of:
maintaining the N1 Non-Access Stratum (NAS) signalling connection between the UE and the network in response to an expiry of the predefined timer and no response from the network for the transmitted registration request; or
encoding an uplink data status to indicate an active state of the established emergency PDU in the registration request.

5. The method of claim 4, wherein the transmitting the registration request for the second network slice in a Registration Request message Requested Network Slice Selection Assistance Information (NSSAI): the first network slice and the second network slice.

6. A method for providing one or more emergency services or emergency service fallback at a User Equipment (UE), the method comprising:
transmitting, to a network via one of a 3GPP or a non-3GPP access, a first signalling request to access one or more regular services;
receiving, from one or more applications associated with the UE, at least one of a request to access the one or more emergency services and an emergency service fallback request while the UE waiting for a response for the first signalling request;
upon receiving the at least one of the request to access the one or more emergency services and the emergency service fallback request, performing at least one of:
aborting a first signalling request procedure, or
transmitting, to the network, at least one of a second signalling request to access the one or more emergency services and the emergency service fallback request; and
transmitting, to the network, at least one of the second signalling request to access the one or more emergency services and the emergency service fallback request in parallel to the first signalling request.

7. The method of claim 6, wherein the transmitting the first signalling request comprises:
transmitting a service request with a status of uplink data for an established regular Packet Data Unit (PDU) on one of the 3GPP access and the non-3GPP access and initiating a predefined timer; or
transmitting a registration request procedure on the one of the 3GPP access and the non-3GPP access for a reason other than emergency services or emergency services fallback or initiating a PDU connection for emergency bearer services or moving out of registration area or due to Inter RAT Change or due to capability update and initiating the predefined timer.

8. The method of claim 6, wherein in response to aborting the first signalling request procedure, the method comprises:
performing, by the UE, one of:
releasing a signalling connection associated with the transmitted first signalling request and stopping an initiated predefined timer; and
determining whether a Radio Access Technology (RAT) or PLMN selection is required;
in response to determining the RAT or PLMN selection is not required, transmitting a second signalling request on a current RAT; or
in response to determining the RAT selection is required, selecting another RAT or PLMN combination and transmitting the second signaling request on the selected another RAT or PLMN combination.

9. The method of claim 8, wherein the transmitting the second signalling request comprises:
initiating one of a service request procedure and a registration request procedure on the UE for the one or more emergency services or emergency service fallback request on a selected another RAT or PLMN combination.
